(19) United States
(12) Patent Application Publication
(10) Pub. No.: US 2020/0333570 A1
(43) Pub. Date: Oct. 22, 2020

(54) ROTATING CLAMPING DEVICE

(71) Applicant: Mauro PEDRETTI, Biasca (CH)

(72) Inventor: Mauro PEDRETTI, Biasca (CH)

(21) Appl. No.: 16/094,869

(22) PCT Filed: Apr. 21, 2017
(86) PCT No.: PCT/IB2017/001213

§ 371 Date: Oct. 18, 2018

Related U.S. Application Data
(60) Provisional application No. 62/325,912, filed on Apr. 21, 2016.

(51) Int. Cl. G02B 19/00; G02B 26/08; H02S 40/22

(52) U.S. Cl. CPC G02B 19/0023; H02S 40/22; G02B 26/0825; G02B 19/0042

(57) ABSTRACT

Disclosed herein are devices, systems, and methods for transitioning a substantially planar mirror (2) to a curved configuration. A device or system may comprise a clamping assembly for associating with a mirror (2) and a rotating assembly configured to rotate at least a portion of a mirror according to a rotation angle (Φ). In some cases, a rotation angle is adjustable.

### CROSS-REFERENCE

This application claims the benefit of U.S. Provisional Patent Application No. 62/325,912, filed Apr. 21, 2016, which is entirely incorporated herein by reference.

### BACKGROUND

Solar concentrators are the essential and critical elements of a solar energy system. To date, a great variety of solar concentrators are available on the market. The majority of existing solar concentrators utilize parabolic mirrors to concentrate the solar energy.

### SUMMARY

An aspect of the present disclosure provides a device for transitioning a substantially planar mirror to a curved configuration. In some cases, the device comprises a clamping assembly and a rotating assembly. In some cases, the clamping assembly is configured to operatively associate with an edge of a substantially planar mirror. In some cases, a rotating assembly is configured to rotate an edge according to a rotation angle by rotating a portion of a clamping assembly about a pivot point such that a substantially planar mirror transitions to a curved configuration. In some cases, a rotating assembly is configured to secure an edge at a rotation angle.

In some cases, the device comprises a longitudinal beam configured to operatively associate with and support a rotating assembly. In some cases, the device comprises a transverse beam configured to operatively associate with and support a longitudinal beam.

In some cases, the device comprises a second clamping assembly. In some cases, a second clamping assembly is configured to operatively associate with a second edge of a substantially planar mirror. In some cases, the device comprises a second rotating assembly configured to (i) rotate a second edge according to a second rotation angle by rotating a portion of a second clamping assembly about a second pivot point and (ii) secure a second edge at a second rotation angle. In some cases, a rotation angle and a second rotation angle are different.

In some cases, the device comprises a second longitudinal beam configured to operatively associate with and support a rotating assembly. In some cases, the device comprises a second longitudinal beam configured to operatively associate with and support a rotating assembly and a second rotating assembly. In some cases, the device comprises a second longitudinal beam configured to operatively associate with and support a second rotating assembly. In some cases, a transverse beam is configured to operatively associate with and support a longitudinal beam, a second longitudinal beam, or a combination thereof. In some cases, an edge and a second edge are positioned opposite one another.

In some cases, a curved configuration is a substantially cylindrical configuration. In some cases, a curved configuration comprises a curve across at least about 25% of a surface area of a substantially planar mirror. In some cases, a clamping assembly clamps onto an edge.

In some cases, a rotation angle and a second rotation angle are different. In some cases, a rotation angle is a pre-determined rotation angle. In some cases, a pre-determined rotation angle is specified by a user or a controller. In some cases, a substantially planar mirror comprises a mirror width that is substantially identical to a mirror width of a curved configuration.

In some cases, before transitioning, an edge of a substantially planar mirror comprises a thickness. In some cases, before transitioning, an edge comprises a thickness and a second edge comprises a second thickness. In some cases, a thickness of an edge is different than a second thickness of a second edge. In some cases, a thickness of an edge is from about 0.5 mm to about 5 mm.

In some cases, before transitioning, an edge of a substantially planar mirror comprises a length. In some cases, before transitioning, an edge comprises a length and a second edge comprises a second length. In some cases, a length of an edge is different than a second length of a second edge.

In some cases, a substantially planar mirror comprises two mirrors. In some cases, a mirror of two mirrors comprises a thickness that is about half of a thickness of a substantially planar mirror. In some cases, two mirrors are stacked along a vertical direction of a device.

In some cases, a device is configured to resist a load. In some cases, a percent change in a focal length of a curved configuration in response to a load is less than about 1%. In some cases, a load comprises a load from a wind force. In some cases, a load comprises a wind speed from about 1 kilometer per hour (km/hr) to about 140 km/hr.

In some cases, a focal length of a curved configuration remains substantially unchanged over a temperature range. In some cases, a temperature range comprises from about −20 degrees Celsius to about 50 degrees Celsius. In some cases, a temperature range comprises from about 0 degrees Celsius to about 45 degrees Celsius. In some cases, a focal length of a curved configuration changes less than about 0.001% over a temperature range. In some cases, a temperature range is a 50 degrees Celsius range.

In some cases, the device comprises a plurality of transverse beams. In some cases, a transverse beam of a plurality of transverse beams is positioned orthogonal to a longitudinal beam.

In some cases, at least a portion of a substantially planar mirror comprises a reflective surface. In some cases, at least a portion of a substantially planar mirror comprises a non-reflective surface.

In some cases, a rotation angle comprises a range from about 0 degrees to about 320 degrees. In some cases, a rotation angle of an edge is adjustable. In some cases, the device comprises an inflatable element configured to aid in transitioning a substantially planar mirror to a curved configuration. In some cases, a rotation angle is applied at a midline of a substantially planar mirror. In some cases, a midline comprises about 50% of a mirror thickness.

In some cases, a pivot point comprises a notch. In some cases, a clamping assembly comprises a first and a second angle profile. In some cases, a first and second angle profiles are operatively connected. In some cases, a clamping assembly comprises a first two angle profiles and a second clamping assembly comprises a second two angle profiles. In some cases, a first two angle profiles and a second two angle profiles are operatively connected. In some cases, a first and second angle profiles are operatively connected by a bolt. In some cases, a flange of a first and second angle profiles are connected to a top surface or a bottom surface of a substantially planar mirror.

In some cases, a rotating assembly comprises: a metal, a metal alloy, a polymer, or any combination thereof. In some cases, a rotating assembly comprises: steel, stainless steel, aluminum, fiberglass, carbon fiber, acrylic, poly(methyl methacrylate), nylon, polycarbonate, or any combination thereof.

In some cases, a longitudinal beam comprises: a metal, a metal alloy, a polymer, a concrete, or any combination thereof. In some cases, a longitudinal beam comprises: steel, stainless steel, aluminum, a cement based material, pre-stressed concrete, ferrocement, polyester concrete, fiberglass, a sandwich panel, or any combination thereof.

In some cases, a focal length of a curved configuration is adjustable. In some cases, a change in a rotation angle results in a change in a focal length of a curved configuration.

In some cases, a cross-section of a curved configuration is configured to locally approximate at least a portion of circumference of a circle. In some cases, a cross-section of a curved configuration is configured to locally approximate at least a portion of a parabola. In some cases, a cross-section of a curved configuration comprises a rotation angle comprising an error from about −1 milliradian to about 1 milliradian. In some cases, a cross-section of a curved configuration is configured to locally approximate at least a portion of an aplanatic shape. In some cases, a curved configuration is configured to locally approximate at least a portion of paraboloid. In some cases, a curved configuration is configured for a linear solar collector.

In some cases, a substantially planar mirror comprises a substantially uniform thickness. In some cases, a substantially uniform thickness is from about 0.0001 millimeters (mm) to about 3 mm. In some cases, an edge comprises a length of a substantially planar mirror in a longitudinal direction. In some cases, a thermal expansion coefficient of a longitudinal beam, a transverse beam, or both is substantially identical to a thermal expansion coefficient of a substantially planar mirror.

Another aspect of the present disclosure provides a solar collector. In some cases, the solar collector comprises a device. In some cases, the solar collector comprises a slope error from about −1 milliradian to about 1 milliradian. In some cases, the solar collector comprises an adjustable focal length. In some cases, a slope error is caused by wind pressure, temperature change, geometry of a curved configuration, or any combination thereof.

Another aspect of the present disclosure provides a method of transitioning a substantially planar mirror to a curved configuration. In some cases, the method comprises operatively connecting a clamping assembly with an edge of a substantially planar mirror; rotating an edge according to a rotation angle by rotating a portion of a clamping assembly about a pivot point such that a substantially planar mirror transitions to a curved configuration. In some cases, the method comprises securing an edge at a rotation angle.

In some cases, the method comprises applying a force with an inflatable element. In some cases, the method comprises a surface comprising a reflective portion. In some cases, a force comprises a bending force. In some cases, the method comprises operatively connecting a second clamping assembly with a second edge of a substantially planar mirror. In some cases, the method comprises rotating a second edge. In some cases, the method comprises operatively connecting a rotating assembly to a longitudinal beam. In some cases, the method comprises operatively connecting a longitudinal beam to a transverse beam. In some cases, a longitudinal beam is orthogonal to a transverse beam.

Another aspect of the present disclosure provides a system for transitioning a substantially planar mirror to a curved configuration. In some cases, the system comprises a clamping assembly, a rotating assembly, and a controller. In some cases, a clamping assembly is configured to operatively associate with an edge of a substantially planar mirror. In some cases, a rotating assembly is configured to (i) rotate an edge according to a rotation angle by rotating a portion of a clamping assembly about a pivot point such that a substantially planar mirror transitions to a curved configuration and (ii) secure an edge at a rotation angle. In some cases, a controller operatively is coupled to the rotating assembly. In some cases, a controller is configured to receive an input comprising a rotation angle and direct the rotating assembly to rotate an edge according to an input.

In some cases, an input is provided by a user. In some cases, the system comprises a user interface. In some cases, a user interface comprises a graphical user interface. In some cases, the system comprises a sensor. In some cases, a sensor is configured to sense a parameter. In some cases, a parameter comprises a coordinate of a light source, an intensity of a light source, a type of light source, a wind load, a seismic load, a temperature, or any combination thereof. In some cases, a light source is sun light. In some cases, a type of light source comprises UV light, visible light, infrared light, or any combination thereof. In some cases, a controller determines a rotation angle based on a parameter. In some cases, a controller determines a rotation angle based on at least 2 parameters. In some cases, a controller adjusts a rotation angle based on a parameter. In some cases, a sensor continuously senses a parameter. In some cases, a sensor senses a parameter at a specified time interval.

In one aspect, disclosed herein are devices for bending a flat mirror into a cylindrical mirror and holding the cylindrical mirror against deformation, the device comprising: a first and a second clamping assembly, wherein the first clamping assembly is configured to clamp onto a first edge of the flat mirror, and wherein the second clamping assembly is configured to clamp onto a second edge of the flat mirror, the first edge and the second edge being opposite to each other; a first and a second rotating assembly configured to allow rotation of the first and the second edge through rotation of part of the first clamping assembly about a first pivot point and rotation of part of the second clamping assembly about a second pivot point such that the flat mirror is bent into the cylindrical mirror, wherein the first rotating assembly is configured to apply a pre-determined rotation angle to the first edge and fasten the first edge at said angle, and wherein the second rotating assembly is configured to apply the pre-determined rotation angle to the second edge and fasten the second edge at said angle; a first and a second longitudinal supporting beam configured to connect and support said rotating assemblies, wherein the first rotating assembly is mounted onto the first longitudinal supporting beam and the second clamping assembly is mounted onto the second longitudinal supporting beam; and one or more transverse beam configured to connect and support the first and the second longitudinal beams. In some cases, the flat mirror comprises a mirror width that is substantially identical to a mirror width of the cylindrical mirror. In some cases, each of the first and the second edges comprises a thickness of the flat mirror in a vertical direction before bending. In some cases, each of the first and the second edges comprises a length of the flat mirror in a longitudinal direction. In some cases, the flat mirror may include two mirrors, each of the two mirrors comprising a mirror thickness that is half of a thickness of the flat mirror. In some cases, the device as disclosed herein is configured to be resistive to wind load such that a change in a focal length of the cylindrical mirror caused by a wind speed of less than 136 km per hour is less than 1% of the focal length. In some cases, the device as disclosed herein is configured to be resistive to temperature-induced such that a change in a focal length of the cylindrical mirror caused by a temperature change of 50 degrees Celsius is less than 0.001%. In some cases, each of the one or more transverse beams is positioned such that it is orthogonal to the first and the second longitudinal beams. In some cases, the flat mirror comprises: a reflective surface, wherein the reflective surface is configured to face upward; a non-reflective surface; and a thickness, wherein the first and the second edges are configured to allow adjustable rotation. In some cases, the flat mirror further comprises at least two or three mirror plates stacked along a vertical direction. In some cases, the device disclosed herein comprises an inflatable element for bending the flat mirror to a cylindrical mirror such that the first edge and the second edge of the flat mirror rotate for the pre-determined rotation angle. In some cases, the pre-determined rotation angle is applied at a midline of the flat mirror at 50% of mirror thickness and at the first and the second edge of the flat mirror. In some cases, the first rotating assembly comprises a notch, the notch being the first pivot point and wherein the second rotating assembly comprises a second notch, the second notch being the second pivot point. In some cases, the first clamping assembly comprises two angle profiles and the second rotating assembly comprises another two angle profiles. In some cases, the two angle profiles of each clamping assembly are connected together by a bolt. In some cases, a flange of each of two angle profiles is connected to a top surface or a bottom surface of the mirror. In some cases, the first and the second rotating assembly comprises: steel, stainless steel, aluminum, fiberglass, carbon fiber, Plexiglas, nylon, polycarbonate, or a combination thereof. In some cases, the first and the second longitudinal supporting beam comprise: steel, stainless steel, aluminum, a cement based material, pre-stressed concrete, ferrocement, polyester concrete, fiberglass, a sandwich panel, or a combination thereof. In some cases, a focus length of the cylindrical mirror is configured to be adjustable by changing the pre-determined rotation angle. In some cases, a cross section of the cylindrical mirror is a portion of a circumference of a circle. In some cases, a cross-section of the cylindrical mirror is configured to locally approximate a parabola. In some cases, the cross-section of the curved mirror comprises an edge rotation angle with an error within a range of −1 milliradian to 1 milliradian. In some cases, a cross-section of the curved mirror is configured to locally approximate an aplanatic shape. In some cases, the cylindrical mirror is configured to locally approximate a paraboloid. In some cases, the cylindrical mirror is part of a linear solar collector. In some cases, the flat mirror comprises a uniform thickness, the thickness being no less than 1 mm, 2 mm, or 3 mm. In some cases, the first and the second edge of the mirror comprises a length of the flat mirror in a longitudinal direction. In some cases, a thermal expansion coefficient of at least one longitudinal beam, at least one transverse beam, or both is substantially identical to a thermal expansion coefficient of the flat mirror.

In another aspect, disclosed herein are solar collectors with adjustable focal length comprising: one or more clamping devices as disclosed herein; and a slope error within a range of −1 milliradian to 1 milliradian, wherein the slope error is caused by wind pressure, temperature change, geometry of one or more cylindrical mirrors, or a combination thereof. In some cases, the flat mirror comprises a mirror width that is substantially identical to a mirror width of the cylindrical mirror. In some cases, each of the first and the second edges comprises a thickness of the flat mirror in a vertical direction before bending. In some cases, each of the first and the second edges comprises a length of the flat mirror in a longitudinal direction. In some cases, the flat mirror may include two mirrors, each of the two mirrors comprising a mirror thickness that is half of a thickness of the flat mirror. In some cases, the clamping device as disclosed herein is configured to be resistive to wind load such that a change in a focal length of the cylindrical mirror caused by a wind speed of less than 136 km per hour is less than 1% of the focal length. In some cases, the clamping device as disclosed herein is configured to be resistive to temperature-induced such that a change in a focal length of the cylindrical mirror caused by a temperature change of 50 degrees Celsius is less than 0.001%. In some cases, each of the one or more transverse beams is positioned such that it is orthogonal to the first and the second longitudinal beams. In some cases, the flat mirror comprises: a reflective surface, wherein the reflective surface is configured to face upward; a non-reflective surface; and a thickness, wherein the first and the second edges are configured to allow adjustable rotation. In some cases, the flat mirror further comprises at least two or three mirror plates stacked along a vertical direction. In some cases, the clamping device disclosed herein comprises an inflatable element for bending the flat mirror to a cylindrical mirror such that the first edge and the second edge of the flat mirror rotate for the pre-determined rotation angle. In some cases, the pre-determined rotation angle is applied at a midline of the flat mirror at 50% of mirror thickness and at the first and the second edge of the flat mirror. In some cases, the first rotating assembly comprises a notch, the notch being the first pivot point and wherein the second rotating assembly comprises a second notch, the second notch being the second pivot point. In some cases, the first clamping assembly comprises two angle profiles and the second rotating assembly comprises another two angle profiles. In some cases, the two angle profiles of each clamping assembly are connected together by a bolt. In some cases, a flange of each of two angle profiles is connected to a top surface or a bottom surface of the mirror. In some cases, the first and the second rotating assembly comprises: steel, stainless steel, aluminum, fiberglass, carbon fiber, Plexiglas, nylon, polycarbonate, or a combination thereof. In some cases, the first and the second longitudinal supporting beam comprise: steel, stainless steel, aluminum, a cement based material, pre-stressed concrete, ferrocement, polyester concrete, fiberglass, a sandwich panel, or a combination thereof. In some cases, a focus length of the cylindrical mirror is configured to be adjustable by changing the pre-determined rotation angle. In some cases, a cross section of the cylindrical mirror is a portion of a circumference of a circle. In some cases, a cross-section of the cylindrical mirror is configured to locally approximate a parabola. In some cases, the cross-section of the curved mirror comprises an edge rotation angle with an error within a range of −1 milliradian to 1 milliradian. In some cases, a cross-section of the curved mirror is configured to locally approximate an aplanatic shape. In some cases, the cylindrical mirror is configured to locally approximate a paraboloid. In some cases, the cylindrical mirror is part of a linear solar collector. In some cases, the flat mirror comprises a uniform thickness, the thickness being no less than 1 mm, 2 mm, or 3 mm. In some cases, the first and the second edge of the mirror comprises a length of the flat mirror in a longitudinal direction. In some cases, a thermal expansion coefficient of at least one longitudinal beam, at least one transverse beam, or both is substantially identical to a thermal expansion coefficient of the flat mirror.

In yet another aspect, disclosed herein are methods of bending a flat mirror into a cylindrical mirror, the method comprising: clamping a first clamping assembly onto a first edge of the flat mirror and clamping a second clamp assembly onto a second edge of the flat mirror, the first and the second edge of the flat mirror being opposite to each other; applying a bending force using an inflatable element on a reflective surface of the flat mirror; rotating the first and the second edge of the flat mirror at a pre-determined rotation angle through rotation of part of the first clamping assembly about a first pivot point and rotation of part of the second clamping assembly about a second pivot point using a first and a second rotating assembly such that the flat mirror is bent into the cylindrical mirror; fastening the first rotating assembly to a first longitudinal beam and fastening the second rotating assembly to the second longitudinal beam such that the first and the second edge are fasten at the pre-determined rotation angle to the first and the second longitudinal beam; and connecting the first and the second longitudinal beam by one or more transverse beams, wherein each transverse beam is orthogonal to said longitudinal beams. In some cases, the flat mirror comprises a mirror width that is substantially identical to a mirror width of the cylindrical mirror. In some cases, each of the first and the second edges comprises a thickness of the flat mirror in a vertical direction before bending. In some cases, each of the first and the second edges comprises a length of the flat mirror in a longitudinal direction. In some cases, the flat mirror may include two mirrors, each of the two mirrors comprising a mirror thickness that is half of a thickness of the flat mirror. In some cases, the method as disclosed herein is configured to be resistive to wind load such that a change in a focal length of the cylindrical mirror caused by a wind speed of less than 136 km per hour is less than 1% of the focal length. In some cases, the clamping method as disclosed herein is configured to be resistive to temperature-induced such that a change in a focal length of the cylindrical mirror caused by a temperature change of 50 degrees Celsius is less than 0.001%. In some cases, each of the one or more transverse beams is positioned such that it is orthogonal to the first and the second longitudinal beams. In some cases, the flat mirror comprises: a reflective surface, wherein the reflective surface is configured to face upward; a non-reflective surface; and a thickness, wherein the first and the second edges are configured to allow adjustable rotation. In some cases, the flat mirror further comprises at least two or three mirror plates stacked along a vertical direction. In some cases, the clamping method disclosed herein comprises inflating an inflatable element for bending the flat mirror to a cylindrical mirror such that the first edge and the second edge of the flat mirror rotate for the pre-determined rotation angle. In some cases, the pre-determined rotation angle is applied at a midline of the flat mirror at 50% of mirror thickness and at the first and the second edge of the flat mirror. In some cases, the first rotating assembly comprises a notch, the notch being the first pivot point and wherein the second rotating assembly comprises a second notch, the second notch being the second pivot point. In some cases, the first clamping assembly comprises two angle profiles and the second rotating assembly comprises another two angle profiles. In some cases, the two angle profiles of each clamping assembly are connected together by a bolt. In some cases, a flange of each of two angle profiles is connected to a top surface or a bottom surface of the mirror. In some cases, the first and the second rotating assembly comprises: steel, stainless steel, aluminum, fiberglass, carbon fiber, Plexiglas, nylon, polycarbonate, or a combination thereof. In some cases, the first and the second longitudinal supporting beam comprise: steel, stainless steel, aluminum, a cement based material, pre-stressed concrete, ferrocement, polyester concrete, fiberglass, a sandwich panel, or a combination thereof. In some cases, a focus length of the cylindrical mirror is configured to be adjustable by changing the pre-determined rotation angle. In some cases, a cross section of the cylindrical mirror is a portion of a circumference of a circle. In some cases, a cross-section of the cylindrical mirror is configured to locally approximate a parabola. In some cases, the cross-section of the curved mirror comprises an edge rotation angle with an error within a range of −1 milliradian to 1 milliradian. In some cases, a cross-section of the curved mirror is configured to locally approximate an aplanatic shape. In some cases, the cylindrical mirror is configured to locally approximate a paraboloid. In some cases, the cylindrical mirror is part of a linear solar collector. In some cases, the flat mirror comprises a uniform thickness, the thickness being no less than 1 mm, 2 mm, or 3 mm. In some cases, the first and the second edge of the mirror comprises a length of the flat mirror in a longitudinal direction. In some cases, a thermal expansion coefficient of at least one longitudinal beam, at least one transverse beam, or both is substantially identical to a thermal expansion coefficient of the flat mirror.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “figure” and “FIG.” herein), of which:

FIG. 1 shows schematically the geometric difference between a substantially planar mirror and a curved mirror with a substantially cylindrical shape as disclosed herein, in accordance with cases.

FIG. 2 shows the mirror edge of the substantially planar mirror and the curved mirror of FIG. 1.

FIG. 3 shows a non-limiting example of a rotating clamping device for bending a substantially planar mirror into a cylindrical mirror, in accordance with cases.

FIG. 4 shows schematically a cross section of a cylindrical mirror assembly in accordance with cases.

FIG. 5 shows an example of influence of the ambient temperature on the focal length of a cylindrical mirror as disclosed herein, in accordance with cases.

FIG. 6 shows a conventional method to introduce the bending moment for bending a substantially planar mirror.

FIG. 7 shows a comparison of the mirror shape using the clamping devices as disclosed herein with a bending moment of M without a tensile force and the mirror shape using a bending moment with a tensile force using the method in FIG. 6.

FIG. 8 shows a comparison of mirror slopes of the mirror shapes in FIG. 7.

FIG. 9 shows another non-limiting example of a rotating clamping device for bending a substantially planar mirror into a cylindrical mirror, in accordance with cases.

FIG. 10 shows another non-limiting example of a rotating clamping device for bending a substantially planar mirror into a cylindrical mirror, in accordance with cases.

FIG. 11 shows a non-limiting example of introducing edge rotation to a substantially planar mirror, in accordance with cases.

FIG. 12 shows another non-limiting example of a rotating clamping device for bending a substantially planar mirror into a cylindrical mirror, in accordance with cases.

FIG. 13a shows a non-limiting example of a parabolic solar collector comprising multiple cylindrically-shaped mirrors, in accordance with cases.

FIG. 13b shows a non-limiting example of a parabolic solar collector of FIG. 13a in three dimensions comprising multiple cylindrically-shaped mirrors, in accordance with cases.

FIG. 14 shows another non-limiting example of a parabolic solar collector comprising multiple cylindrically-shaped mirrors, in accordance with cases.

FIG. 15 shows an example of a rotating clamping device for bending a mirror.

FIG. 16 shows an example of an edge rotation of a mirror.

FIG. 17 shows an example of a concentrated photovoltaic.

FIG. 18 shows an example of a solar collector.

FIG. 19 shows a computer control system that is programmed or otherwise configured to implement methods provided herein.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

As used herein, the singular forms “a”, “an”, and “the” include plural references unless the context clearly dictates otherwise. Any reference to “or” herein is intended to encompass “and/or” unless otherwise stated.

As used herein, the term “about” means the referenced numeric indication plus or minus 15% of that referenced numeric indication.

The efficiency of a solar system greatly depends on the slope and/or shape precision of a solar collector. It may be possible to approximate the parabolic shape of a solar collector with a certain number of cylindrically shaped mirrors. A parabolic solar concentrator made with cylindrically-shaped mirrors may be advantageous in as it may be easy to manufacture, cost-efficient, resistive to undesired stress caused, for instance, by temperature changes and wind loads. A cylindrical mirror may be made starting out of a substantially planar mirror by applying a constant bending moment at two opposite edges of the substantially planar mirror. Making a cylindrical mirror out of a substantially planar mirror may be theoretically simple and straightforward but can be significantly challenging to achieve practically. Indeed, it may be very difficult to apply a desired bending moment to bend a substantially planar mirror without introducing any spurious tensile forces into the cross section of the mirror. A very small tensile force may have deteriorating effects on the cylindrical shape of the mirror. In addition to that, any small movement, of the two supporting edges of the mirrors, for instance, due to temperature differences and/or wind forces, may further modify the cylindrical shape of the mirror.

The rotating clamping device and the method of using as disclosed herein obviates the above-mentioned problems in bending a substantially planar mirror into a cylindrically mirror. The devices and methods as disclosed herein may allow an easy introduction of the exact rotation at two opposite mirror edges in order to bend the substantially planar mirror to a predefined focal length. The devices and methods as disclosed herein may also hold firmly in place the two opposite edges of the mirror in order to stabilize the mirror against any wind load, and/or to compensate for any ambient temperature variation that might cause changes to the cylindrical shape of a curved mirror.

In one aspect, disclosed herein are devices for bending a substantially planar mirror into a cylindrical mirror and holding the cylindrical mirror against deformation, the device comprising: a first and a second clamping assembly, wherein the first clamping assembly may be configured to clamp onto a first edge of the substantially planar mirror, and wherein the second clamping assembly may be configured to clamp onto a second edge of the substantially planar mirror, the first edge and the second edge being opposite to each other; a first and a second rotating assembly configured to allow rotation of the first and the second edge through rotation of part of the first clamping assembly about a first pivot point and rotation of part of the second clamping assembly about a second pivot point such that the substantially planar mirror may be bent into the cylindrical mirror, wherein the first rotating assembly may be configured to apply a pre-determined rotation angle to the first edge and fasten the first edge at said angle, and wherein the second rotating assembly may be configured to apply the pre-determined rotation angle to the second edge and fasten the second edge at said angle; a first and a second longitudinal supporting beam configured to connect and support said rotating assemblies, wherein the first rotating assembly may be mounted onto the first longitudinal supporting beam and the second clamping assembly may be mounted onto the second longitudinal supporting beam; and one or more transverse beam configured to connect and support the first and the second longitudinal beams. In some cases, the substantially planar mirror comprises a mirror width that may be substantially identical to a mirror width of the cylindrical mirror. In some cases, each of the first and the second edges comprises a thickness of the substantially planar mirror in a vertical direction before bending. In some cases, each of the first and the second edges comprises a length of the substantially planar mirror in a longitudinal direction. In some cases, the substantially planar mirror may include two mirrors, each of the two mirrors comprising a mirror thickness that may be half of a thickness of the substantially planar mirror. In some cases, the device as disclosed herein may be configured to be resistive to wind load such that a change in a focal length of the cylindrical mirror caused by a wind speed of less than about 136 km per hour may be less than about 1% of the focal length. In some cases, the device as disclosed herein may be configured to be resistive to temperature-induced such that a change in a focal length of the cylindrical mirror caused by a temperature change of about 50 degrees Celsius may be less than about 0.001%. In some cases, each of the one or more transverse beams may be positioned such that it may be orthogonal to the first and the second longitudinal beams. In some cases, the substantially planar mirror comprises: a reflective surface, wherein the reflective surface may be configured to face upward; a non-reflective surface; and a thickness, wherein the first and the second edges are configured to allow adjustable rotation. In some cases, the substantially planar mirror further comprises at least two or three mirror plates stacked along a vertical direction. In some cases, the device disclosed herein comprises an inflatable element for bending the substantially planar mirror to a cylindrical mirror such that the first edge and the second edge of the substantially planar mirror rotate for the pre-determined rotation angle. In some cases, the pre-determined rotation angle may be applied at a midline of the substantially planar mirror at about 50% of mirror thickness and at the first and the second edge of the substantially planar mirror. In some cases, the first rotating assembly comprises a notch, the notch being the first pivot point and wherein the second rotating assembly comprises a second notch, the second notch being the second pivot point. In some cases, the first clamping assembly comprises two angle profiles and the second rotating assembly comprises another two angle profiles. In some cases, the two angle profiles of each clamping assembly are connected together by a bolt. In some cases, a flange of each of two angle profiles may be connected to a top surface or a bottom surface of the mirror. In some cases, the first and the second rotating assembly comprises: steel, stainless steel, aluminum, fiberglass, carbon fiber, Plexiglas, nylon, polycarbonate, or a combination thereof. In some cases, the first and the second longitudinal supporting beam comprise: steel, stainless steel, aluminum, a cement based material, pre-stressed concrete, ferrocement, polyester concrete, fiberglass, a sandwich panel, or a combination thereof. In some cases, a focus length of the cylindrical mirror may be configured to be adjustable by changing the pre-determined rotation angle. In some cases, a cross section of the cylindrical mirror may be a portion of a circumference of a circle. In some cases, a cross-section of the cylindrical mirror may be configured to locally approximate a parabola. In some cases, the cross-section of the curved mirror comprises an edge rotation angle with an error within a range of from about −1 milliradian to about 1 milliradian. In some cases, a cross-section of the curved mirror may be configured to locally approximate an aplanatic shape. In some cases, the cylindrical mirror may be configured to locally approximate a paraboloid. In some cases, the cylindrical mirror may be part of a linear solar collector. In some cases, the substantially planar mirror comprises a uniform thickness, the thickness being no less than about: 1 mm, 2 mm, or 3 mm. In some cases, the first and the second edge of the mirror comprises a length of the substantially planar mirror in a longitudinal direction. In some cases, a thermal expansion coefficient of at least one longitudinal beam, at least one transverse beam, or both may be substantially identical to a thermal expansion coefficient of the substantially planar mirror.

In another aspect, disclosed herein are solar collectors with adjustable focal length comprising: one or more clamping devices as disclosed herein; and a slope error within a range of from about −1 milliradian to about 1 milliradian, wherein the slope error may be caused by wind pressure, temperature change, geometry of one or more cylindrical mirrors, or a combination thereof. In some cases, the substantially planar mirror comprises a mirror width that may be substantially identical to a mirror width of the cylindrical mirror. In some cases, each of the first and the second edges comprises a thickness of the substantially planar mirror in a vertical direction before bending. In some cases, each of the first and the second edges comprises a length of the substantially planar mirror in a longitudinal direction. In some cases, the substantially planar mirror may include two mirrors, each of the two mirrors comprising a mirror thickness that may be half of a thickness of the substantially planar mirror. In some cases, the clamping device as disclosed herein may be configured to be resistive to wind load such that a change in a focal length of the cylindrical mirror caused by a wind speed of less than about 136 km per hour may be less than about 1% of the focal length. In some cases, the clamping device as disclosed herein may be configured to be resistive to temperature-induced such that a change in a focal length of the cylindrical mirror caused by a temperature change of about 50 degrees Celsius may be less than about 0.001%. In some cases, each of the one or more transverse beams may be positioned such that it may be orthogonal to the first and the second longitudinal beams. In some cases, the substantially planar mirror comprises: a reflective surface, wherein the reflective surface may be configured to face upward; a non-reflective surface; and a thickness, wherein the first and the second edges are configured to allow adjustable rotation. In some cases, the substantially planar mirror further comprises at least two or three mirror plates stacked along a vertical direction. In some cases, the clamping device disclosed herein comprises an inflatable element for bending the substantially planar mirror to a cylindrical mirror such that the first edge and the second edge of the substantially planar mirror rotate for the pre-determined rotation angle. In some cases, the pre-determined rotation angle may be applied at a midline of the substantially planar mirror at about 50% of mirror thickness and at the first and the second edge of the substantially planar mirror. In some cases, the first rotating assembly comprises a notch, the notch being the first pivot point and wherein the second rotating assembly comprises a second notch, the second notch being the second pivot point. In some cases, the first clamping assembly comprises two angle profiles and the second rotating assembly comprises another two angle profiles. In some cases, the two angle profiles of each clamping assembly are connected together by a bolt. In some cases, a flange of each of two angle profiles may be connected to a top surface or a bottom surface of the mirror. In some cases, the first and the second rotating assembly comprises: steel, stainless steel, aluminum, fiberglass, carbon fiber, Plexiglas, nylon, polycarbonate, or a combination thereof. In some cases, the first and the second longitudinal supporting beam comprise: steel, stainless steel, aluminum, a cement based material, pre-stressed concrete, ferrocement, polyester concrete, fiberglass, a sandwich panel, or a combination thereof. In some cases, a focus length of the cylindrical mirror may be configured to be adjustable by changing the pre-determined rotation angle. In some cases, a cross section of the cylindrical mirror may be a portion of a circumference of a circle. In some cases, a cross-section of the cylindrical mirror may be configured to locally approximate a parabola. In some cases, the cross-section of the curved mirror comprises an edge rotation angle with an error within a range of from about −1 milliradian to about 1 milliradian. In some cases, a cross-section of the curved mirror may be configured to locally approximate an aplanatic shape. In some cases, the cylindrical mirror may be configured to locally approximate a paraboloid. In some cases, the cylindrical mirror may be part of a linear solar collector. In some cases, the substantially planar mirror comprises a uniform thickness, the thickness being no less than about: 1 mm, 2 mm, or 3 mm. In some cases, the first and the second edge of the mirror comprises a length of the substantially planar mirror in a longitudinal direction. In some cases, a thermal expansion coefficient of at least one longitudinal beam, at least one transverse beam, or both may be substantially identical to a thermal expansion coefficient of the substantially planar mirror.

In yet another aspect, disclosed herein are methods of bending a substantially planar mirror into a cylindrical mirror, the method comprising: clamping a first clamping assembly onto a first edge of the substantially planar mirror and clamping a second clamp assembly onto a second edge of the substantially planar mirror, the first and the second edge of the substantially planar mirror being opposite to each other; applying a bending force using an inflatable element on a reflective surface of the substantially planar mirror; rotating the first and the second edge of the substantially planar mirror at a pre-determined rotation angle through rotation of part of the first clamping assembly about a first pivot point and rotation of part of the second clamping assembly about a second pivot point using a first and a second rotating assembly such that the substantially planar mirror may be bent into the cylindrical mirror; fastening the first rotating assembly to a first longitudinal beam and fastening the second rotating assembly to the second longitudinal beam such that the first and the second edge are fasten at the pre-determined rotation angle to the first and the second longitudinal beam; and connecting the first and the second longitudinal beam by one or more transverse beams, wherein each transverse beam may be orthogonal to said longitudinal beams. In some cases, the substantially planar mirror comprises a mirror width that may be substantially identical to a mirror width of the cylindrical mirror. In some cases, each of the first and the second edges comprises a thickness of the substantially planar mirror in a vertical direction before bending. In some cases, each of the first and the second edges comprises a length of the substantially planar mirror in a longitudinal direction. In some cases, the substantially planar mirror may include two mirrors, each of the two mirrors comprising a mirror thickness that may be half of a thickness of the substantially planar mirror. In some cases, the method as disclosed herein may be configured to be resistive to wind load such that a change in a focal length of the cylindrical mirror caused by a wind speed of less than about 136 km per hour may be less than about 1% of the focal length. In some cases, the clamping method as disclosed herein may be configured to be resistive to temperature-induced such that a change in a focal length of the cylindrical mirror caused by a temperature change of about 50 degrees Celsius may be less than about 0.001%. In some cases, each of the one or more transverse beams may be positioned such that it may be orthogonal to the first and the second longitudinal beams. In some cases, the substantially planar mirror comprises: a reflective surface, wherein the reflective surface may be configured to face upward; a non-reflective surface; and a thickness, wherein the first and the second edges are configured to allow adjustable rotation. In some cases, the substantially planar mirror further comprises at least two or three mirror plates stacked along a vertical direction. In some cases, the clamping method disclosed herein comprises inflating an inflatable element for bending the substantially planar mirror to a cylindrical mirror such that the first edge and the second edge of the substantially planar rotate for the pre-determined rotation angle. In some cases, the pre-determined rotation angle may be applied at a midline of the substantially planar at about 50% of mirror thickness and at the first and the second edge of the substantially planar. In some cases, the first rotating assembly comprises a notch, the notch being the first pivot point and wherein the second rotating assembly comprises a second notch, the second notch being the second pivot point. In some cases, the first clamping assembly comprises two angle profiles and the second rotating assembly comprises another two angle profiles. In some cases, the two angle profiles of each clamping assembly are connected together by a bolt. In some cases, a flange of each of two angle profiles may be connected to a top surface or a bottom surface of the mirror. In some cases, the first and the second rotating assembly comprises: steel, stainless steel, aluminum, fiberglass, carbon fiber, Plexiglas, nylon, polycarbonate, or a combination thereof. In some cases, the first and the second longitudinal supporting beam comprise: steel, stainless steel, aluminum, a cement based material, pre-stressed concrete, ferrocement, polyester concrete, fiberglass, a sandwich panel, or a combination thereof. In some cases, a focus length of the cylindrical mirror may be configured to be adjustable by changing the pre-determined rotation angle. In some cases, a cross section of the cylindrical mirror may be a portion of a circumference of a circle. In some cases, a cross-section of the cylindrical mirror may be configured to locally approximate a parabola. In some cases, the cross-section of the curved mirror comprises an edge rotation angle with an error within a range of from about −1 milliradian to about 1 milliradian. In some cases, a cross-section of the curved mirror may be configured to locally approximate an aplanatic shape. In some cases, the cylindrical mirror may be configured to locally approximate a paraboloid. In some cases, the cylindrical mirror may be part of a linear solar collector. In some cases, the substantially planar mirror comprises a uniform thickness, the thickness being no less than about: 1 mm, 2 mm, or 3 mm. In some cases, the first and the second edge of the mirror comprises a length of the substantially planar mirror in a longitudinal direction. In some cases, a thermal expansion coefficient of at least one longitudinal beam, at least one transverse beam, or both may be substantially identical to a thermal expansion coefficient of the substantially planar mirror.

### Overview

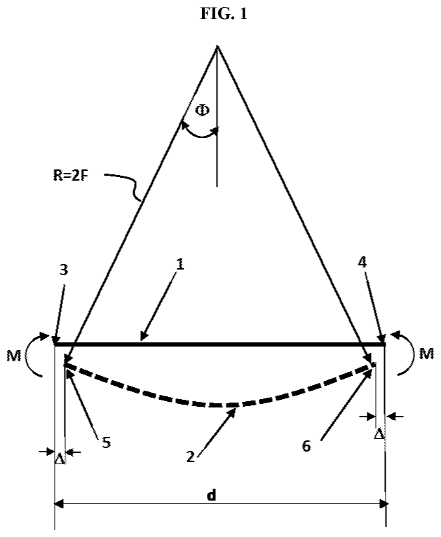

From a theoretical point of view, it may be very simple to apply a bending moment to one or more edges of an initially substantially planar mirror. Practically, this operation may be much more difficult and challenging. FIG. 1 shows schematically the geometric difference between a substantially planar mirror and a curved mirror with a substantially cylindrical shape. The cylindrically-shaped mirror may be bent from the substantially planar mirror. The substantially planar mirror may have a mirror width of d along a transverse direction, a uniform mirror thickness that may be orthogonal to the mirror width along a vertical direction, and a mirror length that may be orthogonal to both the mirror width and the mirror thickness along the longitudinal direction. The mirror may have a mid-plane at about 50% of the mirror thickness. A mirror may have a mid-plane at about 45% of the mirror thickness. A mirror may have a mid-plane at about 55% of the mirror thickness. A mirror may have a mid-plane at about: 30%, 35%, 40%, 45%, 50%, or 55% of the mirror thickness. A mirror may have a mid-plane at from about 45% to about 55% of the mirror thickness. A mirror may have a mid-plane at from about 40% to about 60% of the mirror thickness. A mirror may have a single edge. A mirror may have two edges. A mirror may have a plurality of edges. A mirror may have two opposite edges. Each edge may be a longitudinal plane that may be approximated by a longitudinal line 3, 4. After applying a bending moment M on these edge lines, if free to move, edge 3 may move to 5, and edge 4 may move to point 6. The distance, Δ, between 3 and 5, and between 4 and 6 is:

$$∅ = \frac{d}{2 R} = \frac{d}{4 F}$$

$${d}_{0} = 2 R sin ( ∅ )$$

$$Δ = \frac{1}{2} ( d - {d}_{0} )$$

As a non-limiting example, for a substantially planar mirror with a width of d=600 mm and a desired focal length F=3×d=1800 mm after the substantially planar mirror may be bent into a cylindrical mirror, the distance Δ may be about 0.35 mm. It may be however important to note that, in order to have a good approximation of the parabolic shape of the collector, the aperture d (FIG. 1) of the cylindrical mirror should be smaller than F/3, where F is the focal length of the parabolic collector.

If the two edges 3 and 4 are prevented from moving by the distance Δ, when the bending moment M introduce, the substantially planar mirror may be stressed. The stressed mirror length after bending may be:

$$s = {\int }_{- \frac{d}{2}}^{\frac{d}{2}} \sqrt{1 + {( \frac{d y}{d x} )}^{2}} d x$$

For a cylindrical mirror with a focal length F, the cross-section (orthogonal to the longitudinal direction) of curved mirror in a two-dimensional space may be expressed asy=2F−\sqrt{4F²−x²}.

As another non-limiting examples, for a substantially planar mirror with a width of d=600 mm and a desired focal length F=1800 mm after the substantially planar mirror may be bent into a cylindrical mirror, the mirror length after bending may be s=602.8 mm. The curved mirror may be 2.8 mm longer. The elongation strain ε=(s−d)/d may be 0.47%. With an elastic module E=70000 N/mm² of a substantially planar mirror, if the two supporting edges 3 and 4 are fixed, 0.47% elongation strain may introduce a tension stress of σ=ε×E=328 N/mm². This stress may be much larger than the maximum allowable stress of 30 N/mm² for a mirror, such as a glass mirror. Thus, the mirror breaks under the stress.

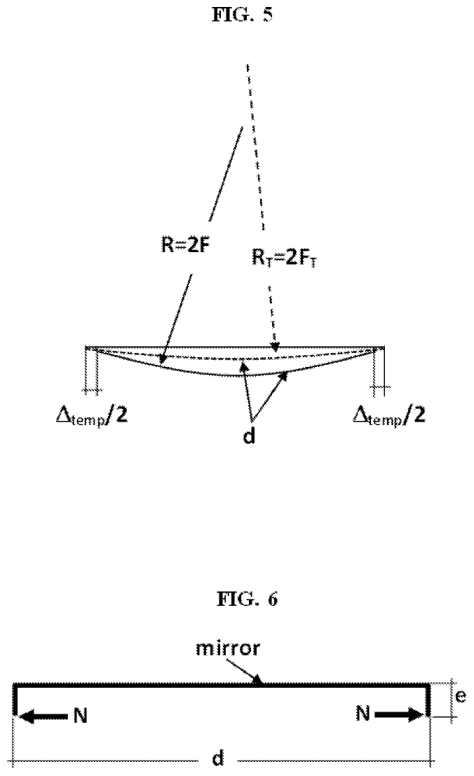

As an example, a very small tensile force N may inevitably modify the mirror shape such that the mirror shape may be not cylinder anymore. In this particular embodiment, a bending moment N×e may be introduced as in FIG. 6 to include a small tensile force N=2 N/mm. A flat mirror, such as a glass mirror has a thickness t=3 mm and a width d=1000 mm with an elastic module E=70000 N/mm². If the bending moment M is introduced through two opposite axial forces N=2 N/mm, with e=20 mm (FIG. 6), M=N×e=40 Nmm/mm, the cross-sectional shape of the curved mirror may be represented by the following differential equation:

$$\frac{{ℊ ( x )}^{″}}{{( 1 + {( {ℊ ( x )}^{′} )}^{2} )}^{\frac{3}{2}}} - \frac{N e + N ℊ ( x )}{EI} = 0$$

This differential equation may be solved numerically.

In another case, if the bending moment M is introduced at two opposite edges substantially without a tensile force N, for bending the flat mirror. For the curved mirror, the cross-sectional mirror shape y (orthogonal to the longitudinal direction) in two-dimension follows the differential equation:

$$\frac{{y ( x )}^{″}}{{( 1 + {( {y ( x )}^{′} )}^{2} )}^{\frac{3}{2}}} - \frac{M}{EI} = 0 ,$$

wherein I=1×t³/12 is the inertia of the mirror of unit length 1 and thickness t. The circle equation y(x)=R−\sqrt{R²−x²} is the solution of the above differential equation, where R=EI/M

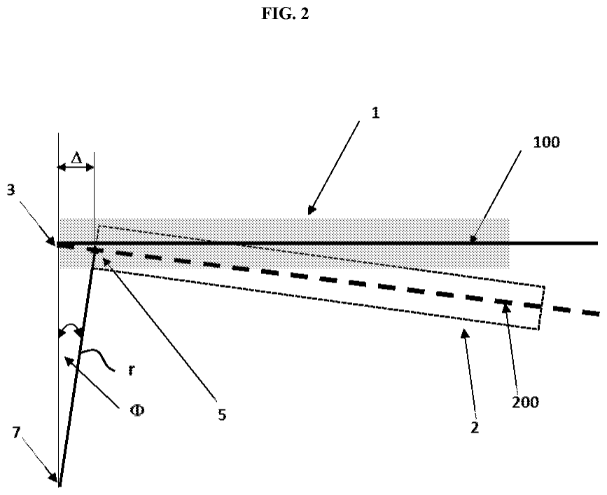

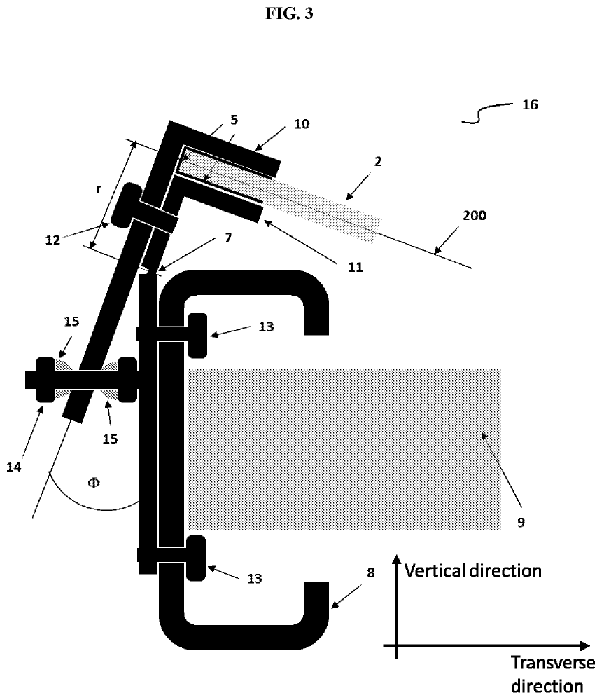

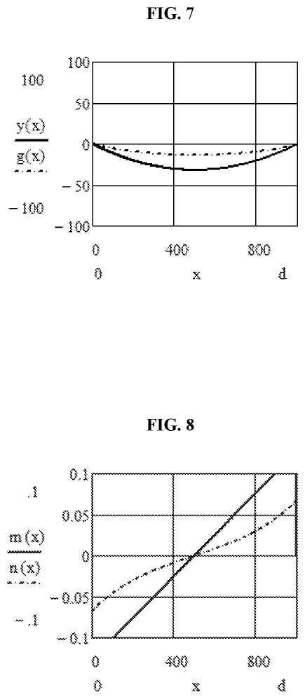

FIG. 7 indicates the cylindrical mirror cross-section of the curved mirror y(x). The bending moment M may be applied continuously along the mirror edges along the longitudinal direction. M may have the dimension Newton×mm/mm. As disclosed herein, a mirror of unit length 1 may be used, thus, the bending moment may be Nmm. As can been seen in FIG. 7, the curved mirror g(x) in two-dimension may be different from a cylindrically shaped mirror y(x). In the same cases, as can be seen in FIG. 8 the two mirror cross sections have significantly different slopes. The slope m(x) is the mirror slope for a cylindrically shaped mirror bent by bending moment M. The slope n(x) is the mirror slope for a bending moment M=N×e including a tensile force N=2 Newton/mm. A very small force N=2 N/mm introduces a stress σ=N/t=0.66 N/mm², and such stress may be sufficient to completely change the shape of the mirror, the cross-sectional shape of the mirror. Thus, it may be very important to have a clamping device that introduces into the mirror edges a bending moment M without any unwanted tensile forces. With the application of a bending moment M, the rotating clamping devices and methods as disclosed herein may allow rotation Φ and the displacement Δ (FIGS. 2 and 3), which may minimize or eliminate any tensile force and unwanted change in mirror shape due to stress.

Referring to FIG. 2, the edge 3 of the substantially planar mirror 1, after applying the bending moment, may rotate to its bent position 5. The center of rotation may be 7, and the radius of rotation r is expressed as:

$$r = \frac{Δ}{sin ( ∅ )} ,$$

wherein F is the desired focal length of 1800 mm and d=600 mm is the mirror width. In this embodiment, r is 4.17 mm. With a desired focal length F, and a mirror width d, a clamping device and mechanism that may precisely impose the rotation angle Φ (Φ=d/2R=d/4F) with the rotation radius r may be able to produce an accurate cylindrical mirror, without introducing unwanted tensile stresses.

FIG. 3 shows a non-limiting example of the clamping device as disclosed herein. A mirror 2, such as a glass mirror, may be clamped between two clamping elements, or extruded aluminum angle profiles, 10 and 11 at two opposite edges (showing only one edge 5). The mirror may be in its bent position or curved configuration. The mirror may be initially flat, the mirror may be bent to be substantially cylindrically-shaped thus rotate from its initial position to position 5 with a rotation angle Φ. The rotation angle may be determined using the mirror width, d, and the desired focal length, F. A mirror may have a thickness of about 3 mm. A mirror may have a thickness of about 2 mm. A mirror may have a thickness of about 1 mm. A mirror may have a thickness of about: 0.5, 1.0, 1.5, 2.0, 2.5, 3.0, 3.5, 4.0, 4.5, 5.0 mm. A mirror may have a thickness of from about 0.01 to about 5.0 mm. A mirror may have a thickness of from about 1.0 to about 4.0 mm. A mirror may have a thickness of from about 1.0 to about 3.0 mm. A mirror may have a thickness of from about 0.01 to about 4.0 mm. A mirror may have a thickness of from about 0.01 to about 3.0 mm. The mirror, such as a mirror may have a mid-plane 200 (viewed as a cross-sectional curved line in FIG. 3) at 50% of the mirror thickness. The mirror may be clamped by the two clamping element such that the edge 5 may be continuously contacting one or both of the clamping elements over the full thickness of the mirror along the vertical direction (when the mirror may be flat and laid horizontal) and/or full length of the mirror along the longitudinal direction. In some cases, the mirror 2 may be glued between the clamping element 10 and 11 at one or more of their contacting surfaces. A fastening bolt 12 may connect the two clamping elements 10 and 11 together. The clamping assembly may include a notch 7. The clamping element 11 and 10 may be rotatable about the notch in a controlled manner so that the notch may serve as a pivot point for the angle profiles 10, 11. When rotated about the pivot point, part of the angle profile may remain fixed to the longitudinal beam 8. In some cases, a fastening unit 13 may be provided to fasten part of the angle profile 11 to the longitudinal beam 8. The pivot point 7 may also remain fixed relative to the longitudinal beam during bending of the mirror. The flange of each of two angle profiles 10, 11 may be in contact with and/or attached to a top surface and a bottom surface of the mirror, respectively. The mirror width that may be contacted with one angle profile on the top or bottom surface may be from about 1 mm to about 20 mm. The rotation may be controlled by a rotating element 14, 15. The rotating element 14, 15 may be anchored at the longitudinal beam to allow fine tuning of the bending angle of the mirror. The distance between the notch and the mirror midline 200 may be the rotation radius r, wherein r may be determined using the rotation angle, Φ, mirror width, d, and displacement Δ. By adjusting the length of the bolt 14, with the spherical washers 15, one can finely adjust the rotation angle Φ of the clamping element 10 and 11. In some cases, the clamping device may allow bending of the mirror 2 at precisely the pre-determined rotation angle Φ without introducing any unwanted tensile force into the mid plane of the mirror 2. The bolt 14 may secure mirror edge 5 firmly into the final bent position. The longitudinal beam 8 may be further connected to a transverse beam 9 for extra support. The mirror 2 may be clamped and supported symmetrically at the edge opposite to edge 5.

In some cases, the mirror as disclosed herein may include an edge 5. The edge of the mirror may include at least part of the side surface of the mirror. The side surface may extend in the vertical direction and the longitudinal direction when the mirror may be flat and lays horizontal. The edge of the mirror may include at least part of the top surface of the mirror, part of the bottom surface of the mirror, and part of the side surface of the mirror. In further cases, the edge of the mirror may include a full side surface, a part of the top surface and a part of the bottom surface, wherein the part of the top surface and/or the part of the bottom surface may have a width of no less than 5 mm along the transverse direction when the mirror may be flat and lays horizontal. The opposite edges of a mirror as disclosed herein are on two opposing side of the mirror along the transverse direction when the mirror may be flat and lays horizontal.

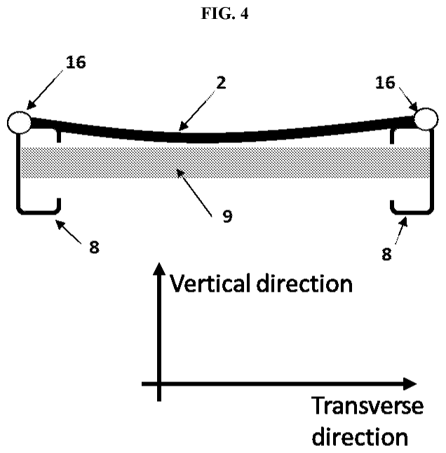

FIG. 4 shows schematically a cross section of a cylindrical mirror assembly. The cylindrical mirror 2 may be clamped at its two opposite edges by rotating clamping devices 16. The rotating clamping device may be connected to and supported by the two longitudinal beams 8. The longitudinal beam may extend along the longitudinal axis of the cylindrical mirror 2. The two longitudinal beams 8 may be connected, at regular spacing, with two or more of transversal beams 9. These transversal beams 9 preferably may be made of a material with a thermal expansion coefficient that may be substantially identical as the thermal expansion coefficient of the mirror material. The match in thermal expansion coefficient may be important in order to minimize any differential movements between the mirror and its edge supports. Without the match of thermal expansion coefficient of the transverse beam, small movements of the mirror edges 5 and 6 due to temperature changes may introduce focal length changes. In the longitudinal direction, the mirror may be linear. Temperature may cause only a linear elongation without changes in focal length. But if the clamping assembly and/or the longitudinal beam have a significant higher thermal expansion coefficient and/or a much higher elastic module than that of the mirror, temperature variation may introduce unwanted longitudinal tensile stress into the mirror. For this reason, elements of the clamping assembly and/or the longitudinal beam may preferably be made of a material with a thermal expansion coefficient similar to the thermal expansion coefficient of the mirror or with a lower elastic module.

FIG. 5 shows the influence of the ambient temperature on the mirror focal length. In this embodiment, the thermal expansion coefficient of the mirror glass (α_{glass}=8×10⁻⁶) may be smaller than the thermal expansion coefficient of the commonly used supporting structure. For a steel structure, the thermal expansion coefficient is αₛₜₑₑₗ=11×10⁻⁶. During a normal daily operation, the mirror and supporting structure may experience a temperature variation of about 50° C. With a ΔT=50° C., mirror (d=1000 mm) may experience an elongation:

d_{glass}=(1+∝_{glass} ΔT)d=600.24 mm.

The steel supporting structure may experience a different elongation:

dₛₜₑₑₗ=(1+∝ₛₜₑₑₗ ΔT)d₀=599.64 mm.

The new mirror bending radius R_{T} may be

$$2 asin ( \frac{\frac{{d}_{s t e e l}}{2}}{{R}_{T}} ) = \frac{{d}_{g l a s s}}{{R}_{T}}$$

R_{T}=3860 mm, and the new focal length F_{T} is R_{T}/2=1930 mm, the focal length difference is 130 mm. The clamping device and methods disclosed herein may practically allow elimination of any focal length variation due to the daily temperature changes during solar collector operation.

The existing parabolic solar collectors are very sensitive to the wind load. In general, a solar collector may stop working at wind speed well below 60 km/h. The wind pressure goes with the square of the wind velocity, at 60 km/h, the wind pressure is 170 MPa at 136 km/h the wind pressure is 860 MPa. In some cases, the clamping device as disclose herein may allow fine adjustment of the mirror shape and mirror position and may also prevent any further movement of the mirror at its bent position, thus the clamping devices and methods as disclose herein may provide significantly higher resistance to wind load than conventional devices used in solar collectors.

As an example, a cylindrical mirror may have a focal length F=1800 mm, a mirror width d=600, and a mirror thickness t=3 mm. A wind load q=860 MPa may introduce to the mirror a tensile stress σ=2F×q/t=1.03 N/mm², and an elongation ε=σ/E=1.47×10⁻⁵ The new mirror length is d_{w}=d×(1+ε)=600.008 mm. The new bending radius may be calculated using the following equations

$$2 asin ( \frac{\frac{{d}_{w}}{2}}{{R}_{w}} ) = \frac{d}{{R}_{w}}$$

The new radius R_{w} 3570 mm. The new focal length due to wind load may be R_{w}/2=1785 mm, which is only 15 mm shorter from the desired focal length of 1800 mm. The rotating clamping device as disclosed herein which includes two continuous longitudinal beams at the mirror edges, and two clamping elements, which clamps the mirror edges on the total mirror length along the longitudinal direction may be very effective in preventing changes in mirror shape and under various wind loads.

Bending a flat plate to a cylindrical surface may introduce some bending stress into the plate. This bending stress may be linearly proportional to the plate thickness according to the following equation:

$$σ = \frac{E}{4 F} t .$$

As can been seen, the mirror bending stress σ is proportional to mirror thickness t. To minimize the mirror bending stress, instead of having a single mirror with thickness t, it may be beneficial to stack more thin mirror with thickness tᵢ in order to obtain the desired total mirror thickness t

t=Σ tᵢ

With this configuration the maximum mirror bending stress may be:

$$σ = \frac{E}{4 F} {t}_{i} .$$

With only two mirrors with thickness t/2, the bending stress may be reduced to only 50% of the original stress. It may be beneficial have three or more mirror plates with thinner thickness. As disclosed herein, the clamping device may be highly effective against wind forces because the mirror rigidity against these forces depend linearly on the total mirror thickness t and mirror radius R according to

$$mirror wind rigidity ∼ \frac{t}{R} , since σ = \frac{E}{4 F} {t}_{i} = \frac{E}{8 R} {t}_{i} .$$

On the opposite, the wind loads rigidity of conventional mirror configuration depends on a beam and plate flexural bending equation. The mirror wind load rigidity may depend linearly on the mirror deflection w. The mirror deflection w depends on mirror width d and mirror thickness t according to the following relation:

$$mirror wind rigidity ∼ w ∼ \frac{{d}^{4}}{I} ∼ \frac{{d}^{4}}{{t}^{3}}$$

Where I is the mirror inertia

$$I = b \frac{{t}^{3}}{12}$$

b is the mirror longitudinal length, for a mirror of unit length, thus b=1. Stacking more mirrors in this case may not help in improving rigidity and the sturdiness of the curved mirror. The mirrors may be stacked together without the need to glue them together. Only the top mirror sheet need a reflective surface, the other sheets stacked underneath the top mirror sheets may be simple glass plate. On the opposite, it may reduce the inertia according to the follow:

$$I = \frac{b}{12} Σ {t}_{i}^{3}$$

Thus, the rigidity of conventionally curved mirror to wind load may significantly drop as the thickness of mirror decreases.

As an example, a conventional mirror with the same dimension experience the same wind load as the mirror and clamping device as disclosed herein. The conventional mirror may suffer a deflection of about 9 mm and the focal length may change of about 700 mm.

The clamping device and methods as disclosed herein may hold firmly in place the two edges of a cylindrical mirror, and the rigidity of our solution depends directly on the mirror thickness t and not on t³. Thus, the clamping device and methods as disclosed herein may be used to clamp and support mirrors composed of two or more plates, each having a thinner mirror thickness in order to reduce bending stress without reducing mirror rigidity and resistance to wind loads.

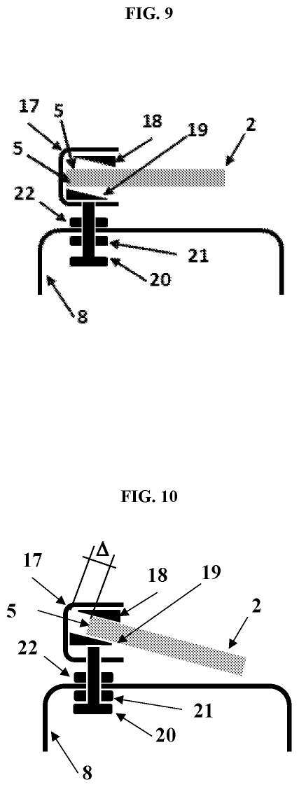

FIG. 9 shows another non-limiting example of a rotating clamping device as disclosed herein. In some cases, the mirror may not yet be clamped to it pre-determined bent position. The mirror 2 may be positioned between two wedges 18 and 19, the mirror may be flat and positioned horizontally between the two wedges. The two wedges may be positioned inside a channel clamping element 17. A bolt 20 may connect the channel clamping element 17 with the longitudinal beam 8. By adjusting both two nuts 21 and 22, the longitudinal beam may be hold in position securely, and geometrical imperfections of the longitudinal beam 8 may be eliminated. By pressing the bolt 20 against the wedge 19, the wedge moves vertically upward toward the wedge 18. The mirror may rotate and slide between the two edges toward its final bent position.

FIG. 10 shows the mirror 2 that may be clamped into its final bent position. The two wedges 18 and 19 may hold the mirror edge firmly at its final position. The mirror 2 may rotate and slides forward Δ from its initial position to its final bent or curved position. In some cases, the clamping element may be the channel profile 17. In some cases, it may be the channel profile in combination with a wedge 18. The rotating element may be the bolt 20 in combination with at least one wedge 19. The connection between the clamping element and the longitudinal beam may be direct through at least a bolt 20.

To assure enough rotational rigidity to the channel profile 17 and at the same time enough clamping force, many regularly spaced bolts 20 along the longitudinal beam 8 may be used. In general this spacing may be about 100 mm.

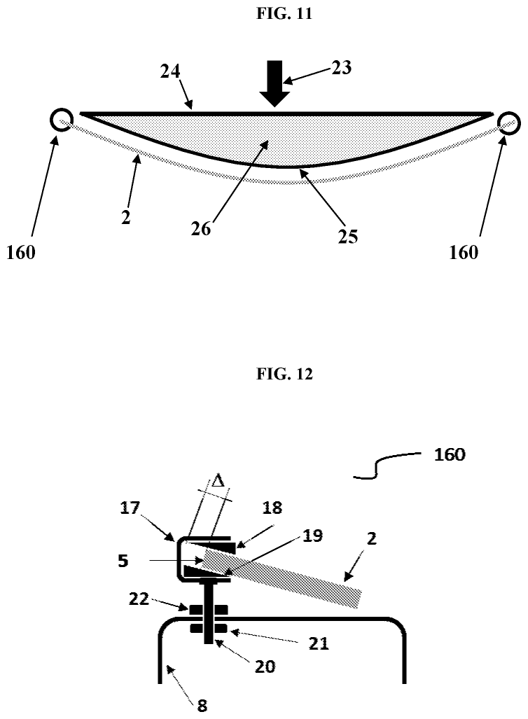

FIG. 11 shows a non-limiting mechanism to easily and precisely introduce rotation at edges of the mirrors. An external force 23 may hold a plate 24 in place. A flexible inflatable membrane 25 may be attached to the fixed plate 24. The volume 26, defined by the fixed plate 24 and the membrane 25 may be filled with gas, preferably air, or liquid, preferably water, at an exactly predefined pressure in order to bend the membrane 25 to the desired mirror radius, R. The mirror radius R is directly related to focal length F as R=2F. The membrane 25 may press against the reflective surface of mirror 2 and bend it to the desired cylindrical shape. After the mirror may be bent to the predetermined cylindrical shape, the mirror may be clamped with its bent shape using clamping devices shown in FIGS. 3, 10.

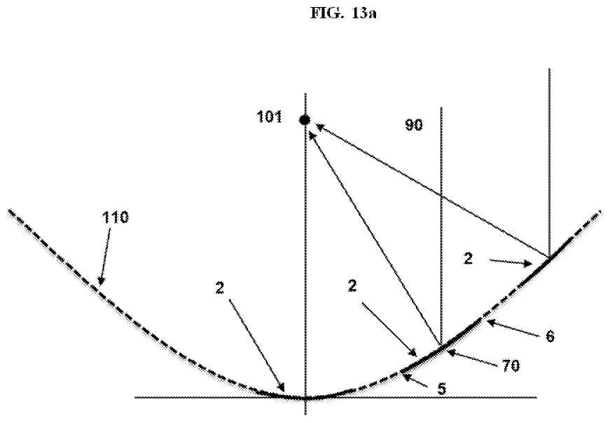

FIG. 12 shows another non-limiting example of a rotating clamping device as disclosed herein. The clamping device may be similar to the clamping device in FIG. 10, but in this case the bolt 20 may be welded to the channel profile 17. The wedge 19 may be in this case directly place on the lower flange of the profile 17. To initiate and prepare for proper bending of the substantially planar mirror 2, the channel profile 17 may be pushed upward vertically to a predetermined height by moving the bolt 20, thus the wedge 19 and the mirror may be moved upward accordingly with the channel profile. When the channel profile has moved to a preselected height, the bolt 20 may be fastened by the two nuts 21, 22 to hold the channel profile at its preselected position. A wedge 18 may be pushed into the channel profile to bend the mirror 2 into its desired rotation angle after the channel profile has been fixed at its desired position. To minimize local mirror stresses, the two wedges 18 and 19 may include a material with an elastic modulus lower as the elastic modulus of the mirror material. For instance, in the case of a glass mirror, the wedges can be made of lead or preferably plastic.

In some cases, the clamping device as disclosed herein may be combined with an inflatable membrane as in FIG. 11 to achieve precise and easy bending of the mirror. In some cases, the channel profile 17 may be firstly pushed upward to a desired height by pushing the bolt 20. The height may be calculated from the shape and size of cylindrical mirror and its edge positions. After the channel profile may be fastened, initial bending may be started with inflating the flexible inflatable membrane 25 and simultaneously bending the two opposite edges (edge 5 as a non-limiting example) of mirror 2. After the mirror has been bent for a rotation angle less than or equal to the preselected rotation angle (in order to reshape it to a cylindrical mirror), a wedge 18 may be inserted to achieve bending to the exact rotation angle thus complete the desired bending from a substantially planar mirror to a cylindrical mirror. After the wedge 18 and 19 has been securely fixed at their positions, the inflatable membrane may be removed without affecting the shape of the curved mirror.

### Curved Mirrors

In some cases, the cylindrically shaped curved mirror may be bent from an off-shelf substantially planar mirror or a plate mirror. In some cases, the cylindrical and substantially planar mirror has at least one reflective surface. In some cases, the cylindrical and substantially planar mirror has at least one reflective surface and at least one non-reflective surface. In some cases, the 2-dimensional cross sections (orthogonal to the longitudinal direction) of the curved mirror approximate a portion of a parabola or a parabolic shape. In some cases, the 2-dimensional cross sections of the curved mirror approximate a portion of a circumference of a circle. In further cases, the 2-dimensional cross sections approximate a portion of a parabola, a parabolic shape, or a cylindrical shape with a slope error of no greater than about: 0.01, 0.02, 0.05, 0.06, 0.08, 0.1, 0.12, 0.15, 0.18, 0.2, 0.21, 0.22, 0.25, or 0.3 milliradian (mrad). A slope error may be from about 0.01 to about 0.3. A slope error may be from about 0.01 to about 0.2. A slope error may be from about 0.01 to about 0.1. A slope error may be from about 0.01 to about 0.05.

In some cases, the longitudinal axis of the curved mirror may be the axis perpendicular to the 2D cross sections. In some cases, the curved mirrors are in a three dimensional space. In some cases, the curved mirror may be a cylindrical mirror. In some cases, the curved mirror has uniformly-shaped and uniformly sized mirrors stacked together continuously along the longitudinal direction. Such that the length of the curved mirror equals the sum of the lengths of individual mirrors. In some cases, the curved mirror may include two or more mirror plate stacked together continuously along the vertical direction or the direction of the mirror thickness. Each mirror may have a mirror thickness that may be identical and sum up to the mirror length of the curved mirror. For examples, a curved mirror of about 3 mm thickness may be stacked using three mirror plates each with a about 1 mm thickness.

In some cases, the curved mirror may be attached to a protection layer or plate at the non-reflective surface. In some cases, the protective plate covers about the entirety of the non-reflective surface. In some cases, the protective plate covers about 90%, 80%, 70%, 60%, or 50% of the surface area of the non-reflective surface of the curved mirror.

In some cases, there may be no protection plate attached to the non-reflective side of the mirror. In some cases, the non-reflective surface of the mirror may be protected with traditionally synthetic protective coating.

In some cases, the curved mirror has a substantially uniform thickness in its cross-section or in 3-dimensions. In some cases, the cylindrical has a non-uniform thickness In some cases, the curved mirror has a thickness of at least about: 2 mm, 2.5 mm, 2.6, 2.7, 2.8 mm, 2.9 mm, 3 mm, 3.1 mm, 3.2 mm, 3.3 mm, 3.4 mm, 3.5 mm, 3.6 mm, 4 mm, 4.5 mm, 5 mm. A curved mirror may have a thickness of from about 2 mm to about 5 mm. A curved mirror may have a thickness of from about 1 mm to about 5 mm. A curved mirror may have a thickness of from about 2 mm to about 4 mm. A curved mirror may have a thickness of from about 3 mm to about 5 mm. In some cases, the curved mirror act statically as a shell or a membrane and may be very stiff against a load, such as a wind load. In some cases, the slope error of curved mirror caused by a wind load may be no more than about: 0.001, 0.005, 0.01, 0.02, 0.05, 0.06, 0.08, 0.1, 0.12, 0.15, 0.18, 0.2, 0.21, 0.22, 0.25, 0.3, 0.4, or 0.5 mrad. A slope error may be from about 0.01 to about 0.3. A slope error may be from about 0.01 to about 0.2. A slope error may be from about 0.01 to about 0.1. A slope error may be from about 0.01 to about 0.05.

In some cases, the curved mirrors are configured to locally approximate a portion of a 3D paraboloid shape so that multiple curved mirrors are configured to approximate a 3D paraboloid shape. In some cases, the surface area of the curved mirrors may be at least about: 50, 80, 100, 120, 150, 180, 200, 400, 500, or 600 times smaller than the surface area of the paraboloid shape. A surface area of a curved mirror may be at least about 50× smaller than a surface area of a paraboloid shape. A surface area of a curved mirror may be at least about 100× smaller than a surface area of a paraboloid shape. A surface area of a curved mirror may be at least about 200× smaller than a surface area of a paraboloid shape. A surface area of a curved mirror may be at least about 400× smaller than a surface area of a paraboloid shape. A surface area of a curved mirror may be at least about 500× smaller than a surface area of a paraboloid shape. A surface area of a curved mirror may be at least about 600× smaller than a surface area of a paraboloid shape. A surface area of a curved mirror may be from about 50× to about 600× smaller than a surface area of a paraboloid shape. A surface area of a curved mirror may be from about 50× to about 400× smaller than a surface area of a paraboloid shape. A surface area of a curved mirror may be from about 50× to about 200× smaller than a surface area of a paraboloid shape.

### Solar Collectors

Conventionally, to produce a parabolic or cylindrical mirror, the manufacturer needs to heat a flat glass and then bend it on a mold. This conventional bending process may be expensive. Further, the curved mirror may have a wavy surface which introduces an optical error of at least about 2 mrad. Further, traditional parabolic mirrors are positioned and hold in place on four supporting points, the only way to improve rigidity of traditional parabolic mirror may be to use thicker mirror, but this may increase mirror weight and obviously the total costs.

Alternatively, using multiple cylindrical mirrors bent from flat mirrors to approximate a parabolic mirror can be easily and cost effective manufactured without any noticeable surface imperfection (waviness). As disclosed herein, a parabolic shape may be precisely approximated using a plurality of cylindrical mirrors. If the width d of the cylindrical mirror may be equal or smaller than F/3 (d<F/3) where F is the collector focal length, the optical error may be smaller than about 0.3 mrad. Such approximation using cylindrical mirror may be much better than the traditional parabolic mirror with at least 2 mrad shape error. Further, the curved mirror and solar collectors as disclosed herein are statically supported along the longitudinal direction as well as the transverse directions. Such configuration may be very flexible against any load and specially, in our case against wind forces. Furthermore, the proposed clamping device as disclosed herein may allow bending of an initially substantially planar mirror to a substantially cylindrical mirror without any optical error (waviness). As disclosed herein, the clamping device may be stiff against any wind load as the bent the mirror may be clamped on the total edge length (longitudinally at least) and the curved mirror may behave statically as a membrane and not as a bending plate.

In some cases, the curved mirrors are placed adjacent to each other with the long axes of them being paralleled to each other to form a solar collector. In some cases, a solar collector includes at least one curved mirrors. In some cases, the curved mirrors are placed adjacent to each other with the cross sections approximating different portion of a same parabolic shape. In some cases, the curved mirrors are placed adjacent to each other with a portion of their cross sections touching a straight line. In further cases, the straight line may be horizontal. In some cases, the straight line may be tilted from the horizontal line.

In some cases, the curved mirrors are arranged so that they collect sunlight to a same solar absorber.

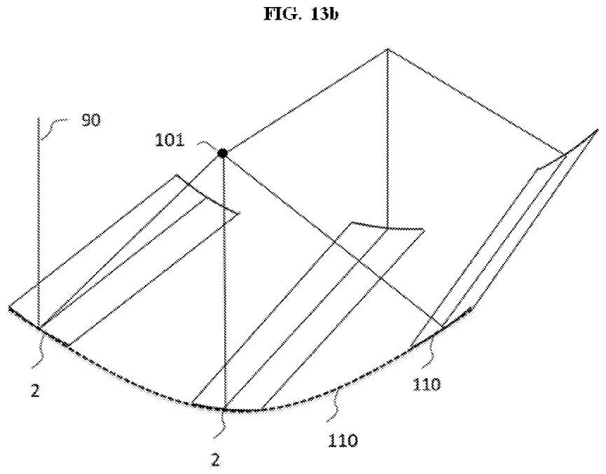

Referring to FIG. 13a, in a particular embodiment, a plurality of curved mirrors 2 are properly placed to locally approximate the parabolic shape 110 of the solar collector and concentrate the solar rays 90 into the focus 101 with different focal lengths. The points 5, 6, and 70 of the cross-sectional curve of the curved mirror 2 are on the parabolic shape 110 as well as on the circumference of a circle.

Referring to FIG. 13b, in a particular embodiment, a plurality of curved mirrors 2 are properly placed to locally approximate the parabolic shape 110 of a cross-section of a three-dimensional solar collector and concentrate the solar rays 90 into the focus 101 with different focal lengths.

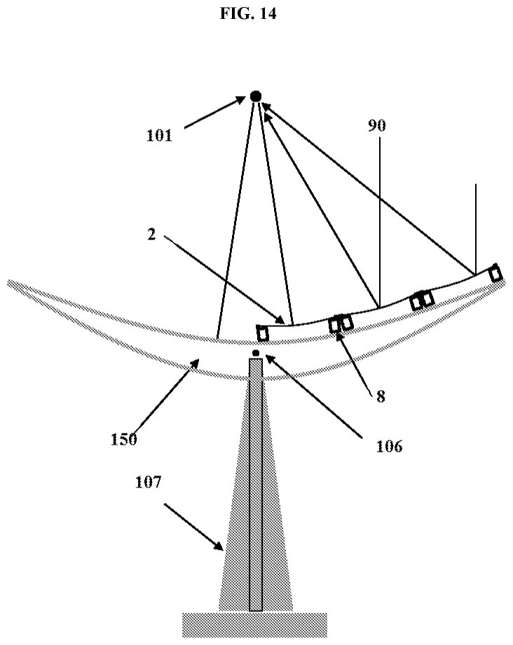

Referring to FIG. 14, in a particular embodiment, the curved mirrors 2 are attached to supporting beams 8 running parallel to the longitudinal axes of the curved mirrors 2. In the same embodiment, the supporting beams are supported by a transversal beam 150 there underneath. In this embodiment, the transversal beam 150 pivots on the pin 106 to connect to a vertically positioned supporting column 107.

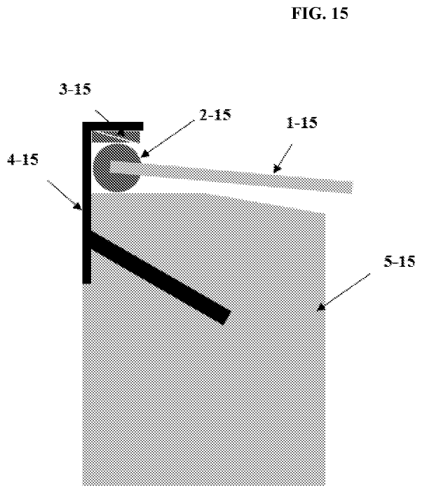

Referring to FIG. 15, a rotating clamping device is shown. A rotating clamping device may bend a mirror, such as a mirror of a solar collector. A substantially planar mirror may be bent to a substantially cylindrical mirror. For example, mirror 1-15 may be inserted into a cylindrically shaped structure 2-15. After bending a substantially planar mirror into a substantially cylindrically shaped mirror, one or more wedges, such as wedge 3-15, may position a mirror in a position. For example, wedge 3-15 may block mirror 1-15 in a cylindrically shaped position. Element 4-15 may be a profile, such as a steel profile that may be associated or connected to a beam 5-15, such as a concrete beam.

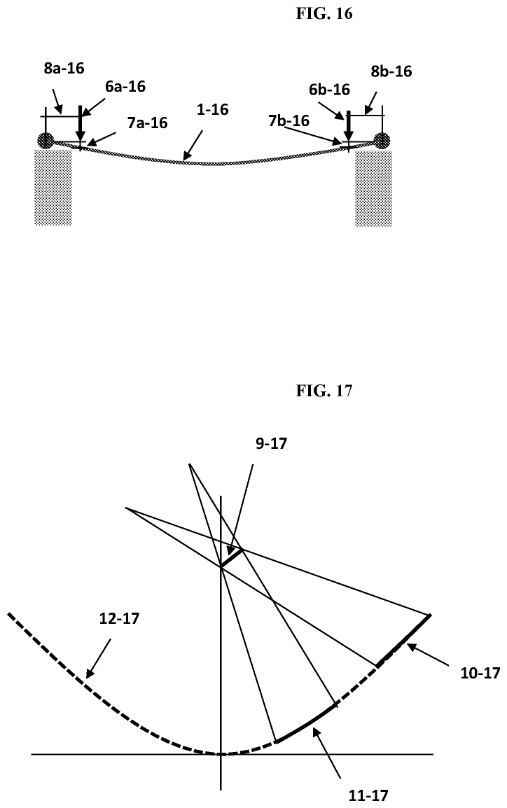

Referring to FIG. 16, an edge rotation of a mirror is shown. For example, one or more forces 6a-16 and 6b-16, such as a longitudinal external force may be applied to a mirror 1-16, such as a substantially planar mirror. The force 6a-16 or 6b-16 may be applied at a given distance 8a-16 or 8b-16, such as about: 30 mm, 40 mm, 45 mm, 50 mm, 55 mm, 60 mm, or 70 mm. The force may be applied at a given distance such as from about 30 mm to about 70 mm. The force may be applied at a given distance such as from about 40 mm to about 60 mm. The force may be applied at a given distance such as from about 45 mm to about 55 mm. The force applied may introduce one or more displacements such as 7a-16 or 7b-16 of the mirror 1-16. The amount of one or more displacements may be controlled. The amount of displacement may be pre-determined, such as by a user or by a controller. The amount of a displacement may be adjusted, such as by a user or by a controller.

Referring to FIG. 17, an example of a photovoltaic is shown, such as a concentrated photovoltaic. A photovoltaic may be a solar panel or solar cell that may convert light energy (such as sunlight) into a flow of electrons. The electricity produced by a photovoltaic may be utilized to recharge a battery or power a solar collector. For optimal performance, it may be advantageous for a photovoltaic to have a uniformly distributed light intensity on its surface, or on a surface of one or more mirrors of the photovoltaic. A traditional parabolic trough may not be able to produce a uniform illumination across a surface. In general, a light intensity of a traditional parabolic trough may have a Gaussian shape. As shown in FIG. 17, devices, systems, and methods as described herein may provide a uniform light distribution on a photovoltaic cell. Unlike a parabolic mirror that may have a fixed focal length, the cylindrical mirrors as described herein may have different focal length. In general, the focal length of a cylindrical mirror may be greater than the focal length of a single parabolic mirror and the photovoltaic cell may not be located at the focal point. As shown in FIG. 17, cylindrical mirrors 10-17 and 11-17 can be adjusted in order to substantially uniformly illuminate a photovoltaic cell 9-17.

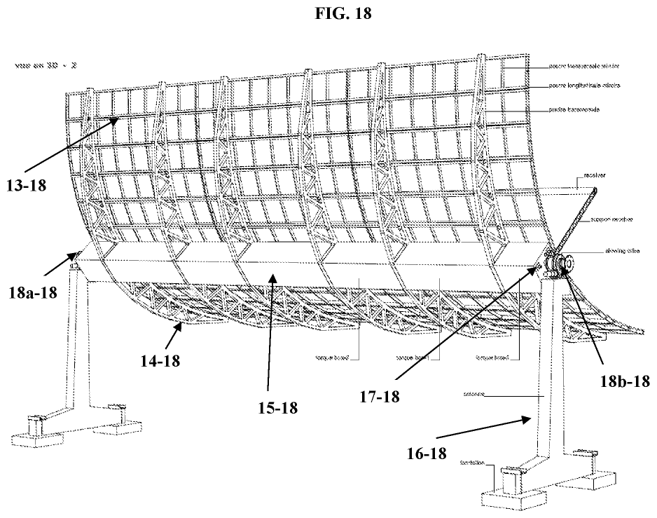

Referring to FIG. 18, a solar collector is shown. A solar collector may comprise one or more of any of the following: a frame, a girder, a box, a tendon, a drive, a column, a mirror or any combination thereof. A solar collector may be anchored or secured to the ground by one or more columns, such as column 16-18. A solar collector may be secured to the ground by two, three, four, or more columns. A column 16-18 may be associated or operatively connected to a slewing drive 18-18. The solar collector may be formed of prefabricated elements. One or more elements of the solar collector may be prefabricated elements. One or more elements of the solar collector may be formed by 3D printing techniques. The solar collector may comprise concrete, metal, metal alloy or any combination thereof. The solar collector may comprise concrete, steel, aluminum, or any combination thereof. The solar collector may comprise concrete. One or more elements of the solar collector may comprise concrete, metal, metal alloy, or any combination thereof. One or more elements of the solar collector may comprise concrete, steel, aluminum, or any combination thereof. One or more elements of the solar collector may comprise concrete. Frame 13-18 may comprise concrete. Frame 13-18 may be configured to hold, position, or associate one or more mirrors in a position, according to the clamping device of FIG. 15. Frame 13-18 may be configured to associate or connect with girder 14-18. One or more girders, such as girder 14-18 may be a transversal girder. One or more girders, such as girder 14-18, may be fitted or pressed adjacent box 15-18, such as pressed between a first box and a second box or such as pressed between a first face of a first box and a second face of the first box. Box 15-18 may be a hollow box. Box 15-18 may be a solid box. Box 15-18 may be a porous box. Box 15-18 may be a concrete box. Box 15-18 may be a concrete hollow box. One or more boxes of the solar collector may be associated or connected together by one or more drives 18a-18 and 18b-18, such as a slewing drive. One or more boxes may be associated or connected at the edges of the boxes by a slewing drive 18a-18 or 18b-18. A tendon 17-18, such as a prestressing tendon, may be positioned at a corner of a box. The tendon may be positioned at an internal corner of a box. The solar collector may comprise 1, 2, 3, 4, 5, 6, 7, 8, or more prestressing tendons. The solar collector may comprise 2 prestressing tendons. The solar collector may comprise 4 prestressing tendons. The tendons may hold the individual elements of the solar collector in a working configuration.

A solar collector may be rotated, such that one or more mirrors are rotated. A solar collector may be rotated about an axis that may be substantially parallel to the ground. A solar collector may be rotated about an axis that may be between substantially parallel to the ground and substantially perpendicular to the ground. A solar collector may be rotated about an axis of about: 10°, 20°, 30°, 40°, 50°, 60°, 70°, 80°, 90°, 100°, 110°, 120°, 130°, 140°, 150°, 160°, 170°, 180°, 190°, 200°, 210°, 220°, 230°, 240°, 250°, 260°, 270°, 280°, 290°, 300° degrees. A solar collector may be rotated from about 10° to about 300° degrees. A solar collector may be rotated from about 10° to about 290° degrees. A solar collector may be rotated from about 10° to about 280° degrees. A solar collector may be rotated from about 10° to about 270° degrees. A solar collector may be rotated at least about 320° degrees. A solar collect may be rotated at least about 300° degrees. A solar collector may be rotated at least about 270° degrees. An individual mirror of the solar collector may be rotated. One or more mirrors of the solar collector may be rotated. The solar collector may be rotated from a position that a mirror may be substantially collecting sunlight to a position that a mirror may be substantially facing a ground, such as during an inclement weather system.

In some cases, the solar collector has a width or length in cross-sectional plane. In some cases, the width and length of the solar collector in the range of from about 0.2 m to about 20 m. In some cases, the longitudinal length of the solar collector, i.e., the length in the direction perpendicular to the cross-sections may be in the range of from about 0.2 m to about 200 m.

### Bending Moments and Bending Elements

In some cases, at least a bending force may be applied directly or indirectly on each of the two opposite edges of the substantially planar mirror. In some cases, the two opposite edges are extending along the longitudinal axis of the curved mirror. In some cases, a plurality of bending forces may be uniformly applied directly or indirectly along the two opposite edges of the substantially planar mirror. In some cases, the indirect application of a bending force to the mirror has at least one additional structural element between the bending element exerting the bending force and the mirror. In some cases, a bending force may be applied directly on the clamping elements clamping on each of the two opposite edges of the substantially planar mirror. In some cases, a bending force may be applied directly on a longitudinal supporting beam attached to each clamping element or each of the two opposite edges of the substantially planar mirror. In some cases, a bending force may be applied directly to one or more selected from: a transverse supporting beam, a fixing element, a clamping element, and a protective plate or layer. In some cases, the bending force generates a bending moment with a bending distance. In some cases, the bending force may be the range of from about 100 Newton (N) to about 10,000 N.

In some cases, a bending moment may be predetermined base on one or more selected from: a mirror width, a mirror thickness, a rotation angle (Φ), an edge displacement during rotation (Δ), a desired focal length, a pivot point, a wind load, a temperature variation, a rotation radius (r), an elastic module of the mirror (E), or a combination thereof. In some cases, a bending moment may not include a tensile force of greater than about 0.00001 N/mm to about 0.1 N/mm. In some cases, a bending moment may not include an axial tensile force of greater than about 0.00001 N/mm to about 0.1 N/mm. The bending moment with an axial force of greater than about 0.00001 N/mm to about 0.1 N/mm may cause stress to the curved mirror and consequently a significantly change in focal length. Such undesired change in focal length may cause deteriorating effects to the efficiency and/or of a solar collector.

In some cases, the bending or clamping assembly may include one or more clamping elements that may be suitable for allowing the substantially planar mirror to rotate and slide into its bent position thus changing the substantially planar mirror into a cylindrical mirror. Non-limiting examples of elements of the clamping assembly may include one or more selected from: a wedge, a clamp, a claw, a screw, a pin, a bolt and a nut, a knob, a latch, a wedge, a beam, a ranch, a gear, a gear set, a pinion, a cam feature, a spring, a nail, a profile, a notch, or the like. In some cases, one or more element of the clamping assembly may directly or indirectly contact the edge of the mirror to exert a bending moment thereon. The edge of the mirror that may be direct contact with the clamping assembly may include a continuous mirror length extending in the longitudinal direction, a continuous mirror thickness extending in the vertical direction when the mirror may be flat, and/or a part of the mirror width extending in the transverse direction when the mirror may be flat.

In some cases, the clamping assembly has two clamping parts facing each other with a gap in between to hold the mirror there between. In some cases, one clamping part contacts the reflective surface and the other clamping part contacts the non-reflective surface of the mirror. In some cases, the clamping parts moves relatively to each other or relative to a longitudinal beam or a transverse beam of the same device as disclosed herein.

In some cases, each clamping element has a wall thickness of no less than about 0.5 mm to about 50 mm. In some cases, the contacting length along the transverse direction of the substantially planar mirror of the clamping element with the mirror may be in the range of from about 5 mm to about 400 mm.

In some cases, the bending or clamping assembly may include a clamping element with an elastic modulus that may be lower than the elastic modulus of the mirror.

### Supporting Beams

In some cases, a longitudinal beam may be included in the clamping device as disclosed herein at one edge of the mirror. In some cases, a longitudinal beam may be included in the clamping device as disclosed herein at the opposite edge of the mirror. The two longitudinal beams at two opposite edges of the mirror are parallel to each other. Each edge may be an edge extending along the longitudinal direction continuously covering substantially the full mirror length. The longitudinal beam may be connected directly to the clamping assembly, the rotating assembly, or both to provide structural support to the curved mirror so that the mirror may be resistive to wind load, temperature change-induce shape change, undesired external impact. The longitudinal beam may also provide support such that the curved mirror may be moved to optimally collect sun power without change to its cylindrical shape.

In some cases, the longitudinal beam may include a material with a thermal expansion coefficient that may be substantially identical to the thermal expansion coefficient of the mirror.

In some cases, a transverse beam may be included in the clamping device as disclosed herein between two parallel longitudinal beams. In some cases, three or more transverse beams are included at regular spacing between the two adjacent transverse beams. Each beam may be orthogonal to both the two parallel longitudinal beams. In some cases, each beam may be attached to a longitudinal beam at an edge along the transverse direction.

In some cases, the longitudinal beam may include a material with a thermal expansion coefficient that may be substantially identical to the thermal expansion coefficient of the mirror.

In some cases, additional support may be provided by the longitudinal supporting beam or the longitudinal and transverse supporting beams. In some cases, the transverse supporting beams are attached to the curved mirror and are perpendicular to the longitudinal supporting beams. In some cases, each of the two transverse supporting beams may be attached close to the two opposite edges of the curved mirror in the longitudinal direction. In some cases, a longitudinal or transverse supporting beam may be attached to a curved mirror, a clamping element, a transverse supporting beam, or a longitudinal supporting beam. In some cases, a single transverse supporting beam may be attached to both edges of the curved mirror.

Referring to FIG. 14, in a particular embodiment, each curved mirror 2 may be attached to two longitudinal supporting beams 8 at its two opposite edges, and the longitudinal supporting beams runs parallel to the longitudinal axes of the curved mirrors 2. In the same embodiment, the longitudinal supporting beams are supported by a transversal supporting beam 150 there underneath. In this embodiment, the transversal beam 150 pivots on the pin 106 to connect to a vertically positioned supporting column 107. Each pair of parallel longitudinal beams may be supported by a plurality of evenly spaced transverse beams (9 in FIG. 3) such that additional support may be added to each curved mirror and may preserve the cylindrical shape of the curved mirror under external impact.

In some cases, the longitudinal supporting beam has a rod shape. In some cases, the longitudinal beam has a rectangular cross section. In some cases, the longitudinal beam has a wall-thickness of no less than 10 mm. In some cases, the longitudinal beam encloses a cuboid empty space there within. In some cases, the cross section of the longitudinal beam has a cross section with two dimensions in the range of 20-500 mm. In some cases, the third dimension of the longitudinal beam may be comparable to the mirror dimension in the longitudinal direction.

In some cases, the transverse supporting beam has a rod shape. In some cases, the transverse supporting beam may be wider at its two ends than the mid-point. In some cases, a transverse supporting beam functions to support an individual mirror or a plurality of mirrors. In some cases, the transverse supporting beam has a curved rod shape in order to accommodate the curved mirror. In some cases, the length of the transverse supporting beam may be in the range of 100-6000 mm. A length of a beam may be from about 100-6000 mm. A length of a beam may be about: 100, 200, 300, 400, 500, 600, 700, 800, 900, 1000, 1500, 2000, 2500, 3000, 3500, 4000, 4500, 5000, 5500, or 6000 mm. A length of a beam may be about: 20, 30, 40, 50, 60, 70, 80, 90, 100, 150, 200, 250, 300, 350, 400, 450, or 500 mm. A length of a beam may be from about 20-500 mm. A length of a beam may be from about 10-1000 mm. A length of a beam may be from about 20-400 mm. A length of a beam may be from about 20-300 mm. A length of a beam may be from about 50-500 mm. A length of a beam may be from about 100-500 mm. In some cases, the width of the transverse supporting beam at its two ends or at its mid-point may be in the range of from about 20 mm to about 500 mm. In some cases, a plurality of transverse supporting beams may be evenly distributed along the longitudinal axis of one or more curved mirror. In some cases, the two ends of a transverse supporting beam connect two longitudinal supporting beams of the same or different mirror. In some cases, the two ends of a transverse supporting beam connect a longitudinal supporting beam and another supporting beam.

### Fixing Elements

In some cases, the fixing element includes two parts. In some cases, one of the two parts may be placed directly or indirectly above the reflective surface of the mirror. In some cases, one of the two parts may be placed directly or indirectly below the non-reflective surface of the mirror. In some cases, the fixing element has a portion to receive a bending element. In some embodiment, the fixing element has a threaded portion to fit in a threaded bending element in order to exert bending force onto the reflective surface of the mirror.

In some cases, the fixing element may be glued, soldered, welded, screwed, nailed, or pined to a supporting element, such as a supporting beam. In some cases, each fixing element has a wall thickness of no less than about 0.5 mm to about 50 mm. In some cases, the contacting length of the fixing element, i.e. within the plane of the cross section of the curved mirror, with the mirror may be in the range of from about 5 mm to about 500 mm.

### Materials

In some cases, the clamping assembly, the bending assembly, the longitudinal beam, and other beams and elements in the clamping device as disclosed herein includes one or more materials selected from: a metal, a ferrocement, a concrete, a pre-stressed concrete, a composite material, and a reinforced material. In some cases, the clamping assembly, the bending assembly, the longitudinal beam, and other beams and elements in the clamping device as disclosed herein includes one or more materials selected from: steel, stainless steel, aluminum, alloy, glass, rubber, polymer, wood, fiberglass, carbon fiber, Plexiglas, nylon, and polycarbonate.

In some cases, the mirrors are made of one or more reflective materials. In some cases, the mirrors, i.e. flat or curved mirrors includes a reflective coating or one or more reflective materials selected from: glass, sliver, aluminum, mercury, aluminized polyester film, polyester, silica, quartz, a metal, silicon oxides, and silicon nitrides. In some cases, the mirrors, i.e. flat or curved mirrors includes a non-reflective coating or includes one or more non-reflective materials selected from: epoxy, polyurethane, silicon, rubber, polyester, steel, aluminum, stainless steel, fiber concrete, polyester concrete, fiberglass, composite materials, and a sandwich panel.

In some cases, a longitudinal or transverse supporting beam may be made of any suitable rigid structural material. No exclusive example of structural materials includes one or more of steel, aluminum, composite material, and prefabricated concrete elements. In some cases, the rigidity of structural material depends on the ratio of E/ρ, where E is Young's Module, and ρ is the specific weight per area. For concrete, E=35000 MPa, ρ=2500 kg/m3, E/ρ=14. For steel with E=210000 MPa, ρ=7800 kg/m3, E/ρ=27. The material with higher rigidity ratio may be a better choice. However, steel costs about 2 Euro/kg and concrete cost about 0.04 Euro/kg. Steel costs 50 times more than concrete. Thus, concrete may be the better choice in term of cost/rigidity ratio. In some cases, rigid structural material with better cost/rigidity ratio may be preferred for the supporting beams.

In some cases, the clamping assembly may include materials which are relatively easy to extrude to different shapes. In some cases, one element of the clamping assembly may be made of one or more material selected from: aluminum, steel, prefabricated concrete, and a composite material. In some cases, one element of the bending assembly may be made of one or more selected from wood, metal, concrete, stainless steel, aluminum, and composite material.

In some cases, ferrocement may be a composite material with E=35 GPa and ρ=2500 kg/m³. In some cases, ferrocement includes a plurality of fine steel mesh layers. In some cases, ferrocement includes a matrix of cement mortar.

### Units

In some cases, a tangent may be a unitless and corresponds to a tangential value of an angle or a slope. In some cases, a slope may be either an angle or a unitless tangent of an angle.

Unless otherwise defined, all technical terms used herein have the same meaning as commonly understood by one of ordinary skill in the art to which this disclosure belongs. As used in this specification and the appended claims, the singular forms “a,” “an,” and “the” include plural references unless the context clearly dictates otherwise. Any reference to “or” herein is intended to encompass “and/or” unless otherwise stated. As used in this specification and the claims, unless otherwise stated, the term “about,” and “approximately” refers to variations of less than or equal to about: +/−1%, +/−2%, +/−3%, +/−4%, +/−5%, +/−6%, +/−7%, +/−8%, +/−9%, +/−10%, +/−11%, +/−12%, +/−14%, or +/−15%, depending on the embodiment. As a non-limiting example, about 100 meters represents a range of from about 95 meters to about 105 meters, from about 90 meters to about 110 meters, or from about 85 meters to about 115 meters depending on the cases. The term “substantially” refers to less than or equal to about: +/−0.01%, +/−0.05%, +/−0.1%, +/−0.5%, +/−1%, +/−2%, +/−3%, +/−4%, +/−5%, +/−6%, +/−7%, +/−8%, +/−9%, or +/−10% variation. As a non-limiting example, substantially identical represents a range of from about −0.01% to about 0.01% difference in some cases, from about −0.1% to about 0.1% difference, depending on the cases.

A device as described herein may transition a substantially planar mirror to a curved configuration. The curved configuration may be a substantially cylindrical shape. A curved configuration may be a circular configuration. A curved configuration may be a parabolic configuration. A curved configuration may comprise a portion of a mirror that may be curved. For example, a curved configuration may comprise a middle portion of a mirror, an edge portion of a mirror, an end portion of a mirror, or any combination thereof that may be curved. A curved configuration may comprise a curve across at least about: 10%, 15%, 20%, 25%, 30%, 40%, 50%, 60%, 70%, 75%, 80%, or 90% of a surface area of a mirror. A curved configuration may comprise a curve across at least about 25% of a surface area of a mirror. A curved configuration may comprise a curve across at least about 50% of a surface area of a mirror. A curved configuration may comprise a curve across at least about 75% of a surface area of a mirror. A curved configuration may comprise a curve across at least about 90% of a surface area of a mirror. A curved configuration may comprise a first curve and a second curve. A first curve and a second curve may comprise different angles. A cross-section of a curved configuration may locally approximate at least a portion of a circumference of a circle. A cross-section of a curved configuration may locally approximate at least a portion of a parabola. A cross-section of a curved configuration may locally approximate at least a portion of an aplanatic shape. A cross-section of a curved configuration may locally approximate at least a portion of a paraboloid. A paraboloid may be an elliptic paraboloid or a hyperbolic paraboloid.

An additional element may aid in transitioning a substantially planar mirror to a curved configuration, such as an inflatable element. An inflatable element may be employed to transitional a planar mirror to a curved configuration. An inflatable element may be employed to transition a planar mirror to a curved configuration and to secure the mirror in the curved configuration. An inflatable element may comprise a membrane, a balloon, or any combination thereof.

A mirror may comprise a substantially uniform thickness. A mirror may comprise a thickness of about: 1, 2, 3, 4, 5 mm. A mirror may comprise a thickness of about 5 mm. A mirror may comprise a thickness of about 4 mm. A mirror may comprise a thickness of about 3 mm. A mirror may comprise a thickness of about 2 mm. A mirror may comprise a thickness of about 1 mm. A mirror may comprise a thickness of from about 1 mm to about 3 mm. A mirror may comprise a thickness of from about 1 mm to about 5 mm. A mirror may comprise a thickness of from about 1 mm to about 4 mm. A mirror may comprise a thickness of from about 0.001 mm to about 5 mm. A mirror may comprise a thickness of from about 0.001 mm to about 4 mm. A mirror may comprise a thickness of from about 0.001 mm to about 3 mm. A mirror may comprise a thickness of from about 0.001 mm to about 2 mm. A mirror may comprise a thickness of from about 0.001 mm to about 1 mm.

A thermal expansion coefficient of a beam may be substantially identical or same to a thermal expansion coefficient of a mirror. A thermal expansion coefficient of a longitudinal beam, a transverse beam, or a combination thereof may be substantially identical or same to a thermal expansion coefficient of a mirror. A thermal expansion coefficient of a beam may not differ by more than about 1%, 5%, or 10% as compared to a thermal expansion coefficient of a mirror. A thermal expansion coefficient of a mirror may be about: 7×10⁻⁶, 8×10⁻⁶, 9×10⁻⁶, 10×10⁻⁶, 11×10⁻⁶, 12×10⁻⁶. A thermal expansion coefficient of a mirror may be from about 7×10⁻⁶ to about 12×10⁻⁶. A thermal expansion coefficient of a mirror may be from about 8×10⁻⁶ to about 11×10⁻⁶. A thermal expansion coefficient of a mirror may be from about 7×10⁻⁶ to about 11×10⁻⁶. A thermal expansion coefficient of a mirror may be from about 8×10⁻⁶ to about 12×10⁻⁶.

A device may comprise a clamping assembly. A device may comprise more than one clamping assembly. A device may comprise 2 clamping assemblies. A device may comprise a plurality of clamping assemblies such as 2, 3, 4, 5, or 6 clamping assemblies. A clamping assembly may be configured to associate with an edge of a mirror. A clamping assembly may be configured to associate with more than one edge of a mirror, such as 2 edges. A clamping assembly may clamp onto an edge of a mirror. A first clamping assembly may associate with a first edge of a mirror and a second clamping assembly may associate with a second edge of the same mirror. A first clamping assembly may associate with a first edge that is positioned opposite to or adjacent to a second edge that is associated with a second clamping assembly. A first clamping assembly may be clamped to a first edge that is positioned opposite to or adjacent to a second edge that may be clamped by a second clamping assembly.

A device may comprise a rotating assembly. A device may comprise more than one rotating assembly. A device may comprise 2 rotating assemblies. A device may comprise a plurality of rotating assemblies such as 2, 3, 4, 5, or 6 rotating assemblies. A rotating assembly may be configured to rotate an edge of a mirror. A rotating assembly may be configured to rotate an edge of a mirror according to a rotation angle. An edge may be rotated by rotating a portion of a clamping assembly about a pivot point. Rotating an edge may cause a substantially planar mirror to transition to a curved configuration, such as a substantially cylindrical configuration. A rotating assembly may secure or fix an edge at a rotation angle, thereby maintaining a curved configuration. A rotating assembly may rotate an edge and may secure the edge at a rotated angle.

An edge may be rotated according to a rotation angle. A rotation angle may be adjustable. A rotation angle may be pre-determined. A rotation angle may be specified by a user or by a controller. A rotation angle may be adjusted in real-time. A rotation angle may be adjusted according to an input. A rotation angle may be adjusted according to a light source, such as sun light. A rotation angle may be adjusted according to a light source pattern, such as a sun light pattern. Adjusting a rotation angle may adjust a focal length of a curved configuration. Adjusting a rotation angle may comprise adjusting from about 0 degrees to about 360 degrees. Adjusting a rotation angle may comprise adjusting from about 0 degrees to about 320 degrees. Adjusting a rotation angle may comprise adjusting from about 0 degrees to about 300 degrees. Adjusting a rotation angle may comprise adjusting from about 0 degrees to about 270 degrees.

A rotation angle may be applied at a midline of a mirror. A rotation angle may be applied at one or more ends of a mirror. A rotation angle may be applied at one or more edges of a mirror. A rotation angle may be applied at any length along a mirror.

A device may comprise one or more longitudinal beams. A longitudinal beam may associate with or support one or more rotating assemblies. A device may comprise 2 longitudinal beams. A first longitudinal beam may associate with a first rotating assembly and a second longitudinal beam may associate with a second rotating assembly. A device may comprise one or more transverse beams. A transverse beam may associate with or support one or more longitudinal beams.

A first rotating assembly may rotate a first edge according to a first rotation angle and a second rotating assembly may rotate a second edge according to a second rotation angle. In some cases, the first and second rotation angle may be same or substantially identical. In some cases, the first and second rotation angle may be different. In some cases, the first and second rotation angle may differ by no more than about: 1%, 2%, 3%, 4%, 5%, 6%, 7%, 8%, 9%, or 10%. In some cases, the first and second rotation angle may differ by no more than about 1%. In some cases, the first and second rotation angle may differ by no more than about 3%. In some cases, the first and second rotation angle may differ by no more than about 5%. In some cases, the first and second rotation angle may differ by no more than about 10%.

A first rotating assembly may independently rotate a first edge. A first rotating assembly may rotate a first edge independent of a second rotating assembly that may rotate a second edge. A first rotating assembly and a second rotating assembly may cooperatively rotate a first and a second edge substantially in parallel.

A substantially planar mirror may comprise a first thickness. In some cases, when the substantially plan mirror transitions to a curved configuration, the mirror may comprises a second thickness. The second thickness of the curved configuration may be same or substantially identical to the first thickness. The second thickness of the curved configuration may be different from the first thickness.

A substantially planar mirror may comprise a first length. In some cases, when the substantially plan mirror transitions to a curved configuration, the mirror may comprises a second length. The second length of the curved configuration may be same or substantially identical to the first length. The second length of the curved configuration may be different from the first length.

A substantially planar mirror may comprise a first width. In some cases, when the substantially plan mirror transitions to a curved configuration, the mirror may comprises a second width. The second width of the curved configuration may be same or substantially identical to the first width. The second width of the curved configuration may be different from the first width.

A mirror may comprise a single mirror. A mirror may comprise more than one mirror. A mirror may comprise a plurality of mirrors. A mirror may comprise 2, 3, 4, 5 or 6 mirrors. For a mirror than comprises 2 mirrors, the 2 mirrors may comprise individual thicknesses that amount to the thickness of the mirror. For mirror that may comprise a plurality of mirrors, the plurality of mirrors may be aligned or stacked, such as in a vertical direction.

A device as described herein may resist a load, such as a wind load, a blunt force load, a seismic tremor load, or any other weather-related load, or any combination thereof. In response to a load, a focal length of a curved configuration may remain substantially unchanged. In response to a load, a change in a focal length of a curved configuration may be less than about: 10%, 5%, 4%, 3%, 2%, 1% or less. In response to a load, a change in a focal length of a curved configuration may be less than about 5%. In response to a load, a change in a focal length of a curved configuration may be less than about 3%. In response to a load, a change in a focal length of a curved configuration may be less than about 1%.

A wind load may comprise a wind speed of less than about: 75, 100, 110, 120, 130, 140, 150, 155, 160 kilometers per hour (km/hr). A wind load may comprise a wind speed of less than about 75 km/hr. A wind load may comprise a wind speed of less than about 100 km/hr. A wind load may comprise a wind speed of less than about 110 km/hr. A wind load may comprise a wind speed of less than about 130 km/hr. A wind load may comprise a wind speed of less than about 155 km/hr. A wind load may comprise a wind speed of from about 75 km/hr to about 160 km/hr. A wind load may comprise a wind speed of from about 75 km/hr to about 150 km/hr. A wind load may comprise a wind speed of from about 75 km/hr to about 140 km/hr.

A seismic load may comprise a Richter magnitude of about: 1, 2, 3, 4, 5, or 6. A seismic load may comprise a Richter magnitude of greater than about: 1, 2, 3, 4, 5, or 6. A seismic load may comprise a Richter magnitude of greater than about 1. A seismic load may comprise a Richter magnitude of greater than about 2. A seismic load may comprise a Richter magnitude of greater than about 3. A seismic load may comprise a Richter magnitude of greater than about 4. A seismic load may comprise a Richter magnitude of greater than about 5.

A focal length of a curved configuration may remain substantially unchanged over a change in temperature. For example, a focal length may remain substantially unchanged from about −10 degrees Celsius to about 50 degrees Celsius. A focal length may remain substantially unchanged from about −20 degrees Celsius to about 40 degrees Celsius. A focal length may remain substantially unchanged from about 0 degrees Celsius to about 50 degrees Celsius. For example, a focal length may change by less than about: 0.0001%, 0.0005%, 0.001%, 0.005%, 0.01% over a specified temperature range. A focal length may change by less than about 0.0001% over a specified temperature range. A focal length may change by less than about 0.001% over a specified temperature range. A focal length may change by less than about 0.01% over a specified temperature range. A focal length may change by less than about 0.1% over a specified temperature range.

A mirror may comprise a reflective surface, a non-reflective surface, or a combination thereof. A portion of a surface area of a mirror may comprise a reflective surface. A portion of a surface area of a mirror may comprise a non-reflective surface. Substantially an entire surface of a mirror may comprise a reflective surface. Substantially an entire surface of a mirror may comprise a reflective surface. For example, a first surface (such as a top surface) may comprise a reflective surface and a second surface (such as a bottom surface) may comprise a non-reflective surface. A mirror may comprise a surface patterned with a reflective surface. A mirror may comprise a continuous or discrete reflective surface. A mirror may comprise a coating or a layer that may comprises a material having reflective properties.

One or more rotating assemblies may comprise a single material or a combination of materials. One or more rotating assemblies may comprise: a metal, a metal alloy, a polymer, or any combination thereof. One or more rotating assemblies may comprise: a steel, a stainless steel, an aluminum, a fiberglass, a carbon fiber, an acrylic, a poly(methyl-methacrylate), a nylon, a polycarbonate, or any combination thereof. A first rotating assembly may comprise a same material as a second rotating assembly. A first rotation assembly may comprise a different material than a second rotating assembly.

One or more beams may comprise a single material or a combination of materials. One or more beams may comprise: a metal, a metal alloy, a polymer, a concrete, or any combination thereof. One or more beams may comprise: a steel, a stainless steel, an aluminum, a cement based material, a pre-stressed concrete, a ferrocement, a polyester concrete, a fiberglass, a sandwich panel, or any combination thereof. A first beam may comprise a same material as a second beam. A first beam may comprise a different material than a second beam. A beam may be a longitudinal beam or a transverse beam.

A clamping assembly may be configured to associate with a portion of a mirror. In some cases, a clamping assembly may associate with an edge portion of a mirror. In some cases, a clamping assembly may associate with an end portion of a mirror. In some cases, a clamping assembly may associate with a central portion of a mirror. In some cases, a clamping assembly may associate with a middle portion of a mirror. In some cases, a clamping assembly may associate with an edge portion, an end portion, a central portion, a middle portion, a surface, or any combination thereof of a mirror. In some cases, a clamping assembly may associate with a surface of a mirror. In some cases, a clamping assembly may associate with an end surface, an edge surface, a middle surface, or any combination thereof of a mirror.

In some cases, a rotating assembly may rotate a portion of the mirror. In some cases, a rotating assembly may rotate the portion of the mirror that is associated with the clamping assembly. In some cases, a rotating assembly may rotate an edge portion, an end portion, a middle portion, a central portion, or any combination thereof of a mirror.

In some cases, a rotating assembly may rotate a portion of a mirror. In some cases, a rotating assembly may rotate a portion of a mirror and secure the portion at the rotated position. In some cases, a rotating assembly does not secure the portion of the mirror at the rotated position. In some cases, a rotating assembly may be adjusted to unsecure or secure the portion of the mirror at the rotated position.

### Computer Control Systems

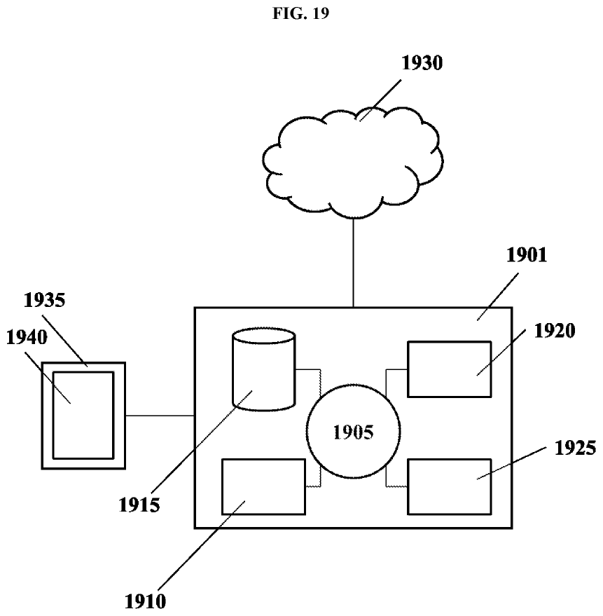

The present disclosure provides computer control systems that are programmed to implement methods of the disclosure. FIG. 19 shows a computer system 1901 that is programmed or otherwise configured to bend one or more mirrors, rotate one or more mirrors, or a combination thereof. The computer system 1901 can regulate various aspects of the solar clamping device and systems of the present disclosure, such as, for example, regulating a force applied to one or more mirrors, regulating a rotation of one or more mirrors, regulating a bending one or more mirrors. The computer system 1901 can be an electronic device of a user or a computer system that is remotely located with respect to the electronic device. The electronic device can be a mobile electronic device.

The computer system 1901 includes a central processing unit (CPU, also “processor” and “computer processor” herein) 1905, which can be a single core or multi core processor, or a plurality of processors for parallel processing. The computer system 1901 also includes memory or memory location 1910 (e.g., random-access memory, read-only memory, flash memory), electronic storage unit 1915 (e.g., hard disk), communication interface 1920 (e.g., network adapter) for communicating with one or more other systems, and peripheral devices 1925, such as cache, other memory, data storage and/or electronic display adapters. The memory 1910, storage unit 1915, interface 1920 and peripheral devices 1925 are in communication with the CPU 1905 through a communication bus (solid lines), such as a motherboard. The storage unit 1915 can be a data storage unit (or data repository) for storing data. The computer system 1901 can be operatively coupled to a computer network (“network”) 1930 with the aid of the communication interface 1920. The network 1930 can be the Internet, an internet and/or extranet, or an intranet and/or extranet that is in communication with the Internet. The network 1930 in some cases is a telecommunication and/or data network. The network 1930 can include one or more computer servers, which can enable distributed computing, such as cloud computing. The network 1930, in some cases with the aid of the computer system 1901, can implement a peer-to-peer network, which may enable devices coupled to the computer system 1901 to behave as a client or a server.

The CPU 1905 can execute a sequence of machine-readable instructions, which can be embodied in a program or software. The instructions may be stored in a memory location, such as the memory 1910. The instructions can be directed to the CPU 1905, which can subsequently program or otherwise configure the CPU 1905 to implement methods of the present disclosure. Examples of operations performed by the CPU 1905 can include fetch, decode, execute, and writeback.

The CPU 1905 can be part of a circuit, such as an integrated circuit. One or more other components of the system 1901 can be included in the circuit. In some cases, the circuit is an application specific integrated circuit (ASIC).

The storage unit 1915 can store files, such as drivers, libraries and saved programs. The storage unit 1915 can store user data, e.g., user preferences and user programs. The computer system 1901 in some cases can include one or more additional data storage units that are external to the computer system 1901, such as located on a remote server that is in communication with the computer system 1901 through an intranet or the Internet.

The computer system 1901 can communicate with one or more remote computer systems through the network 1930. For instance, the computer system 1901 can communicate with a remote computer system of a user (e.g., second personal computer). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 1901 via the network 1930.

Methods as described herein can be implemented by way of machine (e.g., computer processor) executable code stored on an electronic storage location of the computer system 1901, such as, for example, on the memory 1910 or electronic storage unit 1915. The machine executable or machine readable code can be provided in the form of software. During use, the code can be executed by the processor 1905. In some cases, the code can be retrieved from the storage unit 1915 and stored on the memory 1910 for ready access by the processor 1905. In some situations, the electronic storage unit 1915 can be precluded, and machine-executable instructions are stored on memory 1910.

The code can be pre-compiled and configured for use with a machine having a processer adapted to execute the code, or can be compiled during runtime. The code can be supplied in a programming language that can be selected to enable the code to execute in a pre-compiled or as-compiled fashion.

Aspects of the systems and methods provided herein, such as the computer system 1901, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 1901 can include or be in communication with an electronic display 1935 that comprises a user interface (UI) 1940 configured to (a) accept one or more inputs from a user such as a desired angle of mirror rotation or desired amount of mirror bending, (b) collect one or more datapoints from the device or system such as an amount of solar energy collected or an amount of mirror bending, (c) compare one or more collected datapoints to a database of the computer system; (d) output one or more datapoints collected by the device; (e) or any combination thereof. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 1905. The algorithm can, for example, predict an optimal mirror bending or mirror positioning for a given light source, such as a sunlight pattern.

All publications, patents, and patent applications mentioned in this specification are herein incorporated by reference to the same extent as if each individual publication, patent, or patent application was specifically and individually indicated to be incorporated by reference.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A device for transitioning a substantially planar mirror to a curved configuration, the device comprising:
a) a clamping assembly, wherein said clamping assembly is configured to operatively associate with an edge of said substantially planar mirror; and
b) a rotating assembly configured to (i) rotate said edge according to a rotation angle by rotating a portion of said clamping assembly about a pivot point such that said substantially planar mirror transitions to said curved configuration and (ii) secure said edge at said rotation angle.

2. The device of claim 1, further comprising a longitudinal beam configured to operatively associate with and support said rotating assembly.

3. The device of claim 2, further comprising a transverse beam configured to operatively associate with and support said longitudinal beam.

4. The device of any one of claims 1-3, further comprising a second clamping assembly, wherein said second clamping assembly is configured to operatively associate with a second edge of said substantially planar mirror.

5. The device of claim 4, further comprising a second rotating assembly configured to (i) rotate said second edge according to a second rotation angle by rotating a portion of said second clamping assembly about a second pivot point and (ii) secure said second edge at said second rotation angle.

6. The device of claim 5, wherein said rotation angle and said second rotation angle are different.

7. The device of any one of claims 1-6, further comprising a second longitudinal beam configured to operatively associate with and support said rotating assembly.

8. The device of claim 5, further comprising a second longitudinal beam configured to operatively associate with and support said rotating assembly and said second rotating assembly.

9. The device of claim 5, further comprising a second longitudinal beam configured to operatively associate with and support said second rotating assembly.

10. The device of any one of claims 7-9, wherein said transverse beam is configured to operatively associate with and support said longitudinal beam, said second longitudinal beam, or a combination thereof.

11. The device of claim 4, wherein said edge and said second edge are positioned opposite one another.

12. The device of any one of claims 1-11, wherein said curved configuration is a substantially cylindrical configuration.

13. The device of any one of claims 1-11, wherein said curved configuration comprises a curve across at least about 25% of a surface area of said substantially planar mirror.

14. The device of any one of claims 1-13, wherein said clamping assembly clamps onto said edge.

15. The device of claim 5, wherein said rotation angle and said second rotation angle are different.

16. The device of any one of claims 1-15, wherein said rotation angle is a pre-determined rotation angle.

17. The device of claim 16, wherein said pre-determined rotation angle is specified by a user or a controller.

18. The device of any one of claims 1-17, wherein said substantially planar mirror comprises a mirror width that is substantially identical to a mirror width of said curved configuration.

19. The device of any one of claims 1-18, wherein before transitioning, said edge of said substantially planar mirror comprises a thickness.

20. The device of claim 4, wherein before transitioning, said edge comprises a thickness and said second edge comprises a second thickness.

21. The device of claim 20, wherein said thickness of said edge is different than said second thickness of said second edge.

22. The device of claim 19, wherein said thickness of said edge is from about 0.5 mm to about 5 mm.

23. The device of any one of claims 1-18, wherein before transitioning, said edge of said substantially planar mirror comprises a length.

24. The device of claim 4, wherein before transitioning, said edge comprises a length and said second edge comprises a second length.

25. The device of claim 24, wherein said length of said edge is different than said second length of said second edge.

26. The device of any one of claims 1-25, wherein said substantially planar mirror comprises two mirrors.

27. The device of claim 26, wherein a mirror of said two mirrors comprises a thickness that is about half of a thickness of said substantially planar mirror.

28. The device of claim 26, wherein said two mirrors are stacked along a vertical direction of said device.

29. The device of any one of claims 1-28, wherein said device is configured to resist a load.

30. The device of claim 29, wherein a percent change in a focal length of said curved configuration in response to said load is less than about 1%.

31. The device of claim 29, wherein said load comprises a load from a wind force.

32. The device of claim 29, wherein said load comprises a wind speed from about 1 kilometer per hour (km/hr) to about 140 km/hr.

33. The device of any one of claims 1-32, wherein a focal length of said curved configuration remains substantially unchanged over a temperature range.

34. The device of claim 33, wherein said temperature range comprises from about −20 degrees Celsius to about 50 degrees Celsius.

35. The device of claim 34, wherein said temperature range comprises from about 0 degrees Celsius to about 45 degrees Celsius.

36. The device of claim 33, wherein said focal length of said curved configuration changes less than about 0.001% over said temperature range.

37. The device of claim 36, wherein said temperature range is a 50 degrees Celsius range.

38. The device of claim 3, comprising a plurality of transverse beams.

39. The device of claim 38, wherein a transverse beam of said plurality of transverse beams is positioned orthogonal to said longitudinal beam.

40. The device of any one of claims 1-39, wherein at least a portion of said substantially planar mirror comprises a reflective surface.

41. The device of any one of claims 1-40, wherein at least a portion of said substantially planar mirror comprises a non-reflective surface.

42. The device of any one of claims 1-41, wherein said rotation angle comprises a range from about 0 degrees to about 320 degrees.

43. The device of any one of claims 1-42, wherein said rotation angle of said edge is adjustable.

44. The device of any one of claims 1-43, further comprising an inflatable element configured to aid in said transitioning said substantially planar mirror to said curved configuration.

45. The device of any one of claims 1-44, wherein said rotation angle is applied at a midline of said substantially planar mirror.

46. The device of claim 45, wherein said midline comprises about 50% of a mirror thickness.

47. The device of any one of claims 1-46, wherein said pivot point comprises a notch.

48. The device of any one of claims 1-47, wherein said clamping assembly comprises a first and a second angle profile.

49. The device of claim 48, wherein said first and second angle profiles are operatively connected.

50. The device of claim 4, wherein said clamping assembly comprises a first two angle profiles and said second clamping assembly comprises a second two angle profiles.

51. The device of claim 50, wherein said first two angle profiles and said second two angle profiles are operatively connected.

52. The device of claim 51, wherein said first and second angle profiles are operatively connected by a bolt.

53. The device of claim 51, wherein a flange of said first and second angle profiles are connected to a top surface or a bottom surface of said substantially planar mirror.

54. The device of any one of claims 1-53, wherein said rotating assembly comprises: a metal, a metal alloy, a polymer, or any combination thereof.

55. The device of any one of claims 1-53, wherein said rotating assembly comprises: steel, stainless steel, aluminum, fiberglass, carbon fiber, acrylic, poly(methyl methacrylate), nylon, polycarbonate, or any combination thereof.

56. The device of any one of claims 1-55, wherein said longitudinal beam comprises: a metal, a metal alloy, a polymer, a concrete, or any combination thereof.

57. The device of any one of claims 1-55, wherein said longitudinal beam comprises: steel, stainless steel, aluminum, a cement based material, pre-stressed concrete, ferrocement, polyester concrete, fiberglass, a sandwich panel, or any combination thereof.

58. The device of any one of claims 1-57, wherein a focal length of said curved configuration is adjustable.

59. The device of claim 58, wherein a change in said rotation angle results in a change in said focal length of said curved configuration.

60. The device of any one of claims 1-59, wherein a cross-section of said curved configuration is configured to locally approximate at least a portion of circumference of a circle.

61. The device of any one of claims 1-59, wherein a cross-section of said curved configuration is configured to locally approximate at least a portion of a parabola.

62. The device of any one of claims 1-59, wherein a cross-section of said curved configuration comprises a rotation angle comprising an error from about −1 milliradian to about 1 milliradian.

63. The device of any one of claims 1-59, wherein a cross-section of said curved configuration is configured to locally approximate at least a portion of an aplanatic shape.

64. The device of any one of claims 1-59, wherein said curved configuration is configured to locally approximate at least a portion of paraboloid.

65. The device of any one of claims 1-59, wherein said curved configuration is configured for a linear solar collector.

66. The device of any one of claims 1-65, wherein said substantially planar mirror comprises a substantially uniform thickness.

67. The device of claim 66, wherein said substantially uniform thickness is from about 0.0001 millimeters (mm) to about 3 mm.

68. The device of any one of claims 1-67, wherein said edge comprises a length of said substantially planar mirror in a longitudinal direction.

69. The device of claim 3, wherein a thermal expansion coefficient of said longitudinal beam, said transverse beam, or both is substantially identical to a thermal expansion coefficient of said substantially planar mirror.

70. A solar collector comprising:
a) said device of any one of the preceding claims; and
b) a slope error from about −1 milliradian to about 1 milliradian.

71. The solar collector of claim 70, wherein said solar collector comprises an adjustable focal length.

72. The solar collector of claim 70, wherein said slope error is caused by wind pressure, temperature change, geometry of a curved configuration, or any combination thereof.

73. A method of transitioning a substantially planar mirror to a curved configuration, the method comprising:
a) operatively connecting a clamping assembly with an edge of said substantially planar mirror;
b) rotating said edge according to a rotation angle by rotating a portion of said clamping assembly about a pivot point such that said substantially planar mirror transitions to said curved configuration; and
c) securing said edge at said rotation angle.

74. The method of claim 73, further comprising applying a force with an inflatable element.

75. The method of claim 73, further comprising a surface comprising a reflective portion.

76. The method of claim 74, wherein said force comprises a bending force.

77. The method of claim 73, further comprising operatively connecting a second clamping assembly with a second edge of said substantially planar mirror.

78. The method of claim 77, further comprising rotating said second edge.

79. The method of claim 77, further comprising operatively connecting said rotating assembly to a longitudinal beam.

80. The method of claim 73, further comprising operatively connecting said longitudinal beam to a transverse beam.

81. The method of claim 80, wherein said longitudinal beam is orthogonal to said transverse beam.

82. A system for transitioning a substantially planar mirror to a curved configuration, the system comprising:
a) a clamping assembly, wherein said clamping assembly is configured to operatively associate with an edge of said substantially planar mirror;
b) a rotating assembly configured to (i) rotate said edge according to a rotation angle by rotating a portion of said clamping assembly about a pivot point such that said substantially planar mirror transitions to said curved configuration and (ii) secure said edge at said rotation angle; and
c) a controller operatively coupled to the rotating assembly, wherein the controller is configured to receive an input comprising said rotation angle and direct the rotating assembly to rotate said edge according to said input.

83. The system of claim 82, wherein said input is provided by a user.

84. The system of claim 82, wherein said system comprises a user interface.

85. The system of claim 84, wherein said user interface comprises a graphical user interface.

86. The system of claim 82, further comprising a sensor.

87. The system of claim 86, wherein said sensor is configured to sense a parameter.

88. The system of claim 87, wherein said parameter comprises a coordinate of a light source, an intensity of a light source, a type of light source, a wind load, a seismic load, a temperature, or any combination thereof.

89. The system of claim 88, wherein said light source is sun light.

90. The system of claim 88, wherein said type of light source comprises UV light, visible light, infrared light, or any combination thereof.

91. The system of claim 87, wherein said controller determines a rotation angle based on said parameter.

92. The system of claim 91, wherein said controller determines a rotation angle based on at least 2 parameters.

93. The system of claim 87, wherein said controller adjusts a rotation angle based on said parameter.

94. The system of claim 87, wherein said sensor continuously senses a parameter.

95. The system of claim 87, wherein said sensor senses a parameter at a specified time interval.
